(19) United States
(12) Patent Application Publication
(10) Pub. No.: US 2026/0289255 A1
(43) Pub. Date: Sep. 24, 2026

(54) SYSTEM

(71) Applicant: SoftBank Group Corp., Tokyo (JP)

(72) Inventor: Takashi KIRIMURA, Tokyo (JP)

(73) Assignee: SoftBank Group Corp., Tokyo (JP)

(21) Appl. No.: 19/560,199

(22) Filed: Mar. 9, 2026

(30) Foreign Application Priority Data
Mar. 19, 2025 (JP) 2025-044890

(51) Int. Cl. G06N 3/0475; G06N 3/0985; G06Q 30/0601

(52) U.S. Cl. CPC G06N 3/0475; G06N 3/0985; G06Q 30/06311

(57) ABSTRACT

A system includes a processor that is configured to collect data for training on user attribute information and electronic commerce transaction history information, provide an interface through which a user inputs the user's own attribute information and purchase history, and generate a prompt for instructing a generative artificial intelligence model to predict a preference of the user.

### CROSS-REFERENCE TO RELATED APPLICATION

This application is based on and claims priority under 35 USC 119 from Japanese Patent Application No. 2025-044890 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recommendation systems and gift selection support systems generally rely on static rules, collaborative filtering, or simple content-based filtering that uses limited user attribute information or coarse purchase history data. Such systems often fail to accurately capture nuanced individual user preferences, especially where the semantic relationships between user attributes, purchase history, and potential gift items are complex or context-dependent. In addition, many existing systems do not provide a unified mechanism that: (i) systematically collects user attribute information and electronic commerce transaction history for learning, (ii) allows the user to easily input and update such information through a dedicated interface, and (iii) effectively leverages a generative artificial intelligence model as a flexible prediction engine driven by prompts describing a desired inference task. As a result, users may receive irrelevant or generic recommendations, and system providers face difficulty in adapting their services to changing user behavior, reducing overall user satisfaction and limiting the effectiveness of personalized gift proposals.

### SUMMARY

In order to solve the above-described problems, a system according to one aspect of the present invention comprises a processor, wherein the processor is configured to collect data for training on user attribute information and electronic commerce transaction history information, provide an interface through which a user inputs the user's own attribute information and purchase history, and generate a prompt for instructing a generative artificial intelligence model to predict a preference of the user. The processor is further configured to input the user's attribute information and purchase history as features and to predict the preference of the user using the prompt for instructing the generative artificial intelligence model to predict the preference of the user. In addition, the processor is configured to transmit a generated gift candidate to a terminal of the user and to perform communication that enables the user to confirm the proposed gift candidate. By integrating structured data collection, a user-facing input interface, prompt-based control of a generative artificial intelligence model, and bidirectional communication with the user terminal, the system can more accurately infer individual user preferences and present tailored gift candidates that better match the user's tastes and expectations.

The term “system” refers to an overall arrangement including hardware and software components, such as one or more processors, memories, communication interfaces, and program modules, that cooperate to execute the functions defined in the claims.

The term “processor” refers to any hardware device or combination of devices capable of executing instructions, including but not limited to a central processing unit (CPU), a graphics processing unit (GPU), a digital signal processor (DSP), a microcontroller, or a plurality of such units operating together.

The term “user” refers to a person who operates a terminal and interacts with the system, including by inputting attribute information, purchase history, and by viewing or responding to proposed gift candidates.

The term “user attribute information” refers to information that characterizes a user, such as age, gender, hobbies, occupation, demographic data, behavioral preferences, and any other profile-related information that can be associated with the user.

The term “electronic commerce transaction history information” refers to information representing past transactions conducted by the user through electronic commerce, including information on purchased items, purchase dates, quantities, prices, product categories, and identifiers of sellers or platforms.

The term “data for training” refers to a collection of data items, including user attribute information and electronic commerce transaction history information, that is used as input to train, fine-tune, or adapt an artificial intelligence model or related inference logic.

The term “interface” refers to a graphical user interface, web interface, application interface, or any other input/output mechanism presented on a terminal that enables the user to input attribute information and purchase history and to receive outputs such as gift candidates.

The term “purchase history” refers to a subset of the electronic commerce transaction history information that indicates items or services previously bought by the user, including associated metadata such as price, timestamp, and product identifiers.

The term “generative artificial intelligence model” refers to a machine learning model capable of generating outputs such as text, vectors, or other data structures in response to input data and prompts, including but not limited to large language models, generative adversarial networks, and transformer-based generative models.

The term “prompt” refers to data, including textual or structured instructions, provided to the generative artificial intelligence model to specify, constrain, or guide the execution of a particular prediction or generation task, such as predicting a user's preference. The term “preference of the user” refers to a predicted inclination, liking, or interest of the user toward certain items, categories, price ranges, or characteristics of products or services, derived from analysis of user attribute information and purchase history.

The term “features” refers to numerical, categorical, textual, or otherwise encoded representations derived from user attribute information and purchase history that are suitable for input to the generative artificial intelligence model or to auxiliary machine learning components.

The term “gift candidate” refers to an item, product, or service proposed by the system as a potential gift for the user or for a recipient designated by the user, the candidate being selected or generated based on the predicted preference of the user.

The term “terminal” refers to any end-user device capable of communicating with the system, including but not limited to a smartphone, tablet, personal computer, or wearable device, and capable of displaying the interface and receiving gift candidates from the processor.

The term “communication that enables the user to confirm the proposed gift candidate” refers to exchange of data between the processor and the terminal whereby the proposed gift candidate is presented on the terminal and the user is allowed to view, review, approve, reject, or otherwise respond to the proposed gift candidate.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

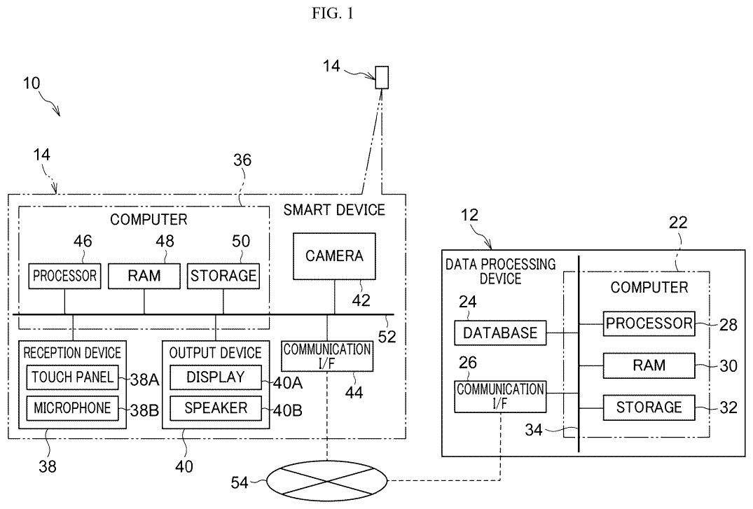

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

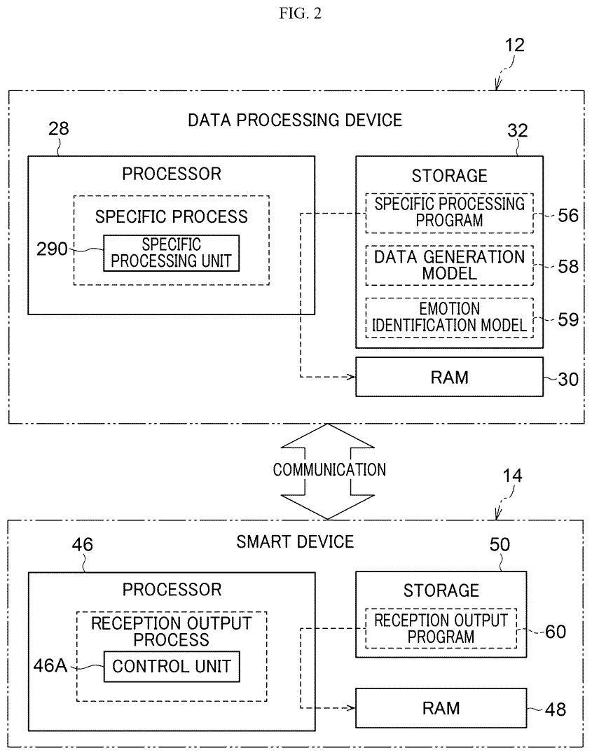

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional gift recommendation systems primarily rely on static rule sets, simple collaborative filtering, or basic predictive models that operate on pre-processed user and transaction data. These systems typically generate recommendation lists directly from numeric scores without a tightly integrated use of generative artificial intelligence models. As a result, such systems suffer from several technical limitations.

First, existing systems often treat prediction processing and natural-language generation as separate, loosely coupled components. Recommendation engines may compute preference scores, while unrelated user-interface logic or external content modules generate text descriptions. This loose coupling increases data transformation overhead, complicates synchronization between score computation and explanation content, and introduces inconsistency between the internal model state and the user-facing outputs.

Second, conventional architectures generally do not maintain a structured, machine-oriented prompt sentence that is programmatically derived from both the internal feature representations and the ranked candidate items. Instead, they tend to construct ad hoc textual descriptions at the presentation layer. This approach prevents deterministic reuse of model features when interacting with a generative AI model, causes redundant encoding and decoding of user and item information, and increases latency and processing load on the computing resources.

Third, conventional systems lack a closed feedback loop that treats the user's selection result as structured learning data integrated back into both the predictive model and the generative prompt construction process. In many cases, user selections are logged only as generic transaction data, without being systematically incorporated into updated feature sets and prompt templates. This reduces the ability of the system to adaptively refine model parameters and prompt structures based on actual user behavior, and thus degrades long-term accuracy and personalization quality.

Fourth, from a computer-technology standpoint, existing systems do not optimize the interplay between a prediction model and a generative AI model. The internal preference prediction is often executed in isolation, and the generative AI model is invoked with high-level, unstructured inputs. This increases computational overhead, leads to suboptimal use of the generative AI model capacity, and may result in redundant or irrelevant content generation, thereby wasting network bandwidth and processing cycles.

Accordingly, there is a need for an improved computer-implemented system that: (i) acquires and stores user-related information and transaction history information in a structured manner, (ii) performs systematic preprocessing to form feature sets for a prediction model, (iii) generates ranked gift candidate items based on learned preference models, (iv) programmatically constructs a structured prompt sentence incorporating both user profile and ranked candidates, and (v) utilizes a generative AI model to produce coherent, personalized recommendation text that is tightly linked to the internal model outputs. Furthermore, there is a need to integrate the user's selection result as learning data for continuous retraining and updating of the prediction model and the prompt construction logic, thereby improving resource efficiency, prediction accuracy, and user experience in a technically grounded manner.

The specific processing by the specific processing unit 290 of the data processing device 12 in Example 1 is realized by the following means.

The present invention provides a server comprising a processor and a storage device, the processor being configured to execute instructions that cause the server to acquire user-related information and transaction history information from a terminal and one or more external information sources and store the acquired information in the storage device; to perform preprocessing on the stored user-related information and transaction history information, the preprocessing including completion of missing values, normalization of attribute values, and numerical representation of categorical information, to generate feature data; to train a learning model using the feature data and past preference results or purchase results to generate and store a prediction model for user preference; to input feature data of a user and attribute information of candidate items into the prediction model to calculate evaluation values indicating degrees of preference for respective candidate items; to rank the candidate items based on the evaluation values and identify a group of gift candidate items; to construct a structured prompt sentence including profile information of the user and information of the group of gift candidate items, and to transmit the prompt sentence to a generative information processing model; to obtain generated text from the generative information processing model and generate recommendation information and explanation information for the gift candidate items based on the generated text; to transmit the group of gift candidate items and the recommendation information to the terminal via a communication network for display and selection by the user; and to acquire a selection result of the user from the terminal, store the selection result in the storage device, and register the stored selection result as learning data used for retraining or updating of the learning model. This enables tighter integration between predictive modeling and generative text processing, reduces redundant data transformations and communication overhead, and provides an adaptive feedback loop that continually refines both the prediction model and the prompt construction, thereby improving the technical performance, efficiency, and personalization capability of the computer-implemented gift recommendation system.

The term “user-related information” refers to information associated with an individual user, including, for example, demographic attributes, behavioral attributes, and preference attributes, such as an age category, a gender category, a preference field category, an occupation category, and other profile information used for modeling the user's characteristics.

The term “transaction history information” refers to information representing records of past interactions of a user with items or services, including, for example, purchase records, browsing records, or selection records, such as item identifiers, categories, timestamps, prices, and quantities.

The term “storage device” refers to a hardware or virtualized component capable of storing data in a non-transitory manner, including, for example, a magnetic storage medium, a solid-state storage medium, or a network-accessible storage system, in which user-related information, transaction history information, feature data, models, and selection results are recorded.

The term “preprocessing” refers to a sequence of data transformation operations performed on raw user-related information and transaction history information to produce feature data suitable for machine learning, including, for example, completion of missing values, normalization or scaling of numerical values, and conversion of categorical information into numerical representations.

The term “completion of missing values” refers to processing that detects absent or undefined data elements in user-related information or transaction history information and replaces the absent elements with substitute values determined according to a predetermined rule or statistical method.

The term “normalization of attribute values” refers to processing that transforms numerical attribute values, such as age or price, into normalized or scaled values according to a predetermined function, such as min-max scaling or standardization, so as to reduce bias due to different value ranges.

The term “numerical representation of categorical information” refers to processing that converts categorical attributes, such as gender, hobby, occupation, or item category, into numerical vectors or indices, for example by one-hot encoding, embedding indexing, or other encoding techniques suitable for machine learning input.

The term “feature data” refers to a structured set of numeric or symbolic values derived from user-related information and transaction history information, which serves as input to a learning model or prediction model to characterize users, items, or interactions.

The term “learning model” refers to a computational model configured to be trained on feature data and associated target values, such as past preference results or purchase results, using a learning algorithm, thereby enabling the model to approximate a mapping from input features to outputs.

The term “prediction model” refers to an instance of a learning model that has been trained on feature data and stored, and that is configured to receive new feature data as input and output prediction values, such as evaluation values indicating degrees of preference.

The term “past preference results or purchase results” refers to labeled information that indicates historical outcomes of user interactions with items, including, for example, whether an item was purchased, selected, rated positively, or otherwise preferred by the user.

The term “candidate items” refers to items that are eligible to be recommended to a user, the items being selected from a broader item catalog based on one or more conditions, such as availability, category, or price range.

The term “attribute information of candidate items” refers to descriptive data associated with each candidate item, including, for example, item category, function summary, price range, brand, popularity, and other item-related attributes.

The term “evaluation value” refers to a numerical value output by the prediction model that represents a degree of preference, relevance, or likelihood of selection of a candidate item by a user.

The term “group of gift candidate items” refers to a subset of candidate items selected and ranked based on evaluation values or other criteria, and designated as recommended items for gifting to or by the user.

The term “profile information” refers to a representation of a user's characteristics at an abstract level, including categorized attributes such as age category, gender category, preference field category, occupation category, and purchased item category, which is used in feature data and prompt sentences.

The term “prompt sentence” refers to a structured textual or symbolic instruction or query, generated by the processor, that encodes user-related information, transaction history information, and information about gift candidate items, and that is transmitted as input to a generative information processing model.

The term “generative information processing model” refers to a machine learning model that is configured to receive a prompt sentence and to generate text or other content in response, such as recommendation sentences or explanation sentences, using probabilistic or neural generation techniques.

The term “generated text” refers to one or more textual outputs produced by the generative information processing model in response to a prompt sentence, including recommendation sentences, explanation sentences, or other natural language content.

The term “recommendation information” refers to text or structured data that recommends one or more gift candidate items to a user, including, for example, recommendation sentences, ranking indicators, and other guidance information.

The term “explanation information” refers to text or structured data that explains why a particular gift candidate item is suitable for a user, including, for example, descriptions of how the item relates to the user's profile information or past behavior.

The term “terminal” refers to a computing apparatus used by a user to interact with the system, including, for example, a smartphone, tablet, personal computer, or other user interface device capable of sending and receiving data over a communication network.

The term “selection result” refers to data indicating a user's choice or non-choice of one or more gift candidate items, including, for example, identifiers of selected items, timestamps, and optional user inputs such as confirmations or comments.

The term “learning data” refers to structured data, including selection results and associated feature data, that is used as input for training, retraining, or updating a learning model or prediction model.

The term “retraining or updating of the learning model” refers to a process in which the learning model is trained again or adjusted using new learning data, including updated user-related information, transaction history information, and selection results, so as to improve prediction accuracy and adapt to changes in user behavior.

In one embodiment, a server, a terminal, and a communication network cooperate to implement a personalized gift recommendation system that integrates a prediction model with a generative AI model through a structured prompt sentence. The server includes at least one processor and at least one non-transitory storage device. The terminal includes at least one processor, a display, an input interface, and a communication interface.

The server uses commercially available hardware such as a multi-core central processing unit and, in some embodiments, a graphics processing unit for acceleration of numerical computation. The server executes an operating system, such as a general-purpose server operating system, and application software implemented, for example, in a scripting language or a compiled language. The server stores user-related information, transaction history information, feature data, trained model parameters, and prompt templates in a database system implemented using a relational database management system or a key-value store.

The terminal uses a processor, a memory, and a display device, and executes a web browser or a native application. The terminal presents user interface screens for input and display and communicates with the server through a secure communication protocol.

The user uses the terminal to provide user-related information, such as an age category, a gender category, a preference field category, an occupation category, and a purchased item category. The user also allows the terminal to send transaction history information, such as item identifiers, item categories, purchase timestamps, and prices, to the server. The terminal transmits this information as structured data to the server via the communication network.

The server stores the user-related information and the transaction history information in the storage device using predefined data structures. For example, the server stores user-related information in a user table that includes fields for a user identifier, age category, gender category, preference category codes, occupation codes, and aggregated purchase statistics.

The server stores transaction history information in a transaction table that includes a user identifier, an item identifier, a category code, a timestamp, a price, and a quantity. These structured data formats allow the server to perform indexed retrieval and efficient aggregation, which improves access speed and reduces computational overhead during model training and inference.

The server performs preprocessing using numerical computation libraries such as a matrix computation library or a data frame library. The server loads raw records from the user table and the transaction table into memory and converts them into an intermediate data structure, such as a matrix or a tensor, suitable for machine learning processing. The server detects missing values in attributes such as age category or preference category and completes missing values by applying a predetermined rule, such as substituting a modal category of users who have similar transaction patterns. The server normalizes attribute values, such as the number of purchases or the logarithm of prices, by applying a scaling operation so that feature values fall into a standard range. The server converts categorical information, such as category codes, into numerical representations by assigning each category to an index and then generating one-hot vectors or lower-dimensional embedding vectors.

The server aggregates transaction history information to generate additional features, such as the number of purchases per category over a predetermined period, the time interval since the latest purchase, the average purchase price, and the diversity of purchased categories. The server combines these features with demographic features into a feature vector for each user.

In one embodiment, the server stores these feature vectors in a feature table, where each row corresponds to a user and each column corresponds to a particular feature dimension. By maintaining a consistent feature schema, the server reduces the need for dynamic feature engineering at inference time and improves throughput.

The server trains a prediction model to estimate evaluation values indicating degrees of preference of a user for candidate items. In one embodiment, the server uses a neural network model implemented on a machine learning framework. The server defines an input layer that receives a concatenated vector of user features and item features. The server defines one or more hidden layers as fully connected layers, each with a predetermined number of nodes and a nonlinear activation function such as a rectified linear unit. The server defines an output layer with a single node that outputs a scalar evaluation value, which represents a predicted probability or score that the user will prefer or select the corresponding item.

The server forms training samples by pairing user feature vectors with item feature vectors and associating each pair with a target label derived from past preference results or purchase results. For example, the server sets a positive label if the item appears in the user's transaction history and a negative or lower label if the item does not appear. The server defines a loss function, such as a logistic loss or a mean squared error, and applies a stochastic gradient descent method or an adaptive optimization method to adjust the neural network weights. The server performs iterative training by dividing the training data into mini-batches and updating the parameters after each batch. The server monitors validation metrics and may apply early stopping or regularization techniques to prevent overfitting.

The server stores the trained parameters of the prediction model, including weight matrices and bias vectors of each layer, in the storage device with version information. The server also stores configuration metadata, such as layer sizes, activation functions, and learned normalization parameters, so that the same architecture can be reconstructed for inference. By doing so, the server can reconstruct the model at runtime without recomputing model configuration, which improves availability and reduces initialization time.

The server generates evaluation values for candidate items at inference time by loading the prediction model into memory and applying the same preprocessing and feature encoding steps as in training. The server retrieves the current user's feature vector and a set of candidate item feature vectors from the storage device. The server constructs input tensors by concatenating each user feature vector with each candidate item feature vector and feeds these tensors into the prediction model. The prediction model performs matrix multiplications and activation operations on the processor or, in some embodiments, on a dedicated accelerator to compute evaluation values for each candidate item. The server sorts the candidate items by evaluation values and selects a group of gift candidate items with the highest scores.

The server constructs a prompt sentence for a generative AI model based on the user-related information, transaction history information, and the group of gift candidate items. The server generates profile information by combining textual phrases corresponding to age category, gender category, preference field category, occupation category, and purchased item category. The server generates item descriptions by extracting item names, function summaries, and price ranges from an item catalog stored in the storage device. The server then combines the profile information and the item descriptions into a structured natural-language prompt.

For example, the server constructs a prompt sentence such as:
“The user is a male in his 30s who loves outdoor activities and has a purchase history of camping gear such as tents, lanterns, sleeping bags, and portable stoves. Based on this profile and the following candidate products: (1) Lightweight 2-person camping tent (approximately 200 dollars), (2) High-performance outdoor knife (approximately 80 dollars), (3) Compact camping lantern (approximately 50 dollars), and (4) Ultralight sleeping bag (approximately 180 dollars), please select the best gift candidates and generate for each item: (a) a short, friendly recommendation message, and (b) a one-sentence explanation of why this gift matches the user's preferences.”

The server transmits this prompt sentence to a generative AI model that is implemented as a large language model. The generative AI model may be executed on the same server or on a remote computing node accessed by an application programming interface. The server specifies parameters such as output length and sampling temperature when calling the generative AI model. The generative AI model internally uses a transformer-based architecture, which includes an embedding layer that converts tokens of the prompt sentence into vector representations, a plurality of self-attention layers that compute attention weights over the token sequence, and feed-forward layers that generate contextualized token embeddings. The generative AI model then generates output tokens sequentially using a decoding strategy such as beam search or top-k sampling. The server receives the generated text as a response to the prompt sentence.

The server parses the generated text to extract recommendation sentences and explanation sentences for each gift candidate item. The server associates each sentence with the corresponding candidate item using identifiers or position information encoded in the prompt.

The server stores these recommendation and explanation texts in the storage device linked to the gift candidate item records. This structured association allows the server to reuse generated content and avoids regeneration when the same candidate item set is displayed again, which reduces the number of generative calls and thereby reduces communication and computation load.

The server transmits the group of gift candidate items and the associated recommendation and explanation information to the terminal. The terminal receives the data and displays a list of gift candidate items to the user, showing each item's name, image, price, evaluation value, recommendation sentence, and explanation sentence. The user views these recommendations on the terminal and selects one or more items. The terminal sends the user's selection result to the server.

The server records the user's selection result as learning data. The server associates the selected items with the user identifier and writes an entry into the transaction table or a feedback table. The server later uses these feedback entries as additional positive samples during model retraining. By periodically retraining the prediction model with the updated learning data, the server adapts model weights to recent user behavior patterns. This feedback-driven update improves prediction accuracy and helps the system reflect changes in user preferences over time.

In one embodiment, the server also adjusts the prompt construction rules based on observed performance of recommendation messages. For example, when the server detects that recommendations generated with a richer profile description lead to higher selection rates, the server increases the amount of profile detail included in prompt sentences. Conversely, the server may reduce prompt length if latency or token usage exceeds a threshold. This adaptive prompt construction modifies not only the prediction model parameters but also the interface between the prediction model and the generative AI model, thereby improving overall system efficiency.

The system improves computer technology in several ways. The server uses a specific data structure and preprocessing pipeline to convert raw user-related information and transaction history information into feature data suitable for both prediction and prompt generation. By integrating the prediction model and the generative AI model through a structured prompt sentence, the server reduces redundant encoding of user and item information. Instead of separately computing recommendation lists and generating generic text, the server uses evaluation values from the prediction model to select a small group of gift candidate items and encodes only these items into the prompt sentence. This selection reduces the token length of prompts, lowers processing time and memory utilization on the generative AI model, and decreases network bandwidth usage.

Moreover, the server performs a non-conventional combination of operations: it uses evaluation values as computational signals to control which items are described in the prompt, and it incorporates both profile features and item features into a textual representation that is optimized for generative processing. This hybrid feature-to-text translation leverages the internal structure of the machine learning features to drive generative behavior, rather than simply mirroring user input. As a result, the system achieves improved consistency between internal scoring and external explanations, and reduces the likelihood that the generative AI model outputs irrelevant recommendations.

The server also implements a particular training and retraining strategy that uses actual user selection results as labels for both the prediction model and the prompt construction heuristic. By maintaining a feedback loop that connects selection results to model weights and prompt formation parameters, the system achieves a technical effect of continuously refining computational models to reduce prediction error, improve ranking quality, and shorten response time. In contrast to human-based gift selection, which relies on manual evaluation, the server performs high-dimensional vector computations and neural network inference, which cannot be practically performed by a human at comparable speed and scale.

Alternative embodiments may use different model architectures or feature sets while preserving the same technical principles. For example, the server may use a gradient boosting decision tree model instead of a neural network for initial preference prediction, or may use a convolutional or recurrent network for processing sequence-based transaction histories. The server may also use additional features such as temporal patterns, device types, or geographic information to refine evaluation values. The generative AI model may be located on an external cloud platform or deployed as an on-premise model. In each case, the server continues to construct structured prompt sentences using encoded profile information and ranked gift candidate items, and continues to use the selection results as learning data.

In another embodiment, the server may generate intermediate representations of feature vectors as textual tags, such as “frequent buyer of outdoor goods” or “prefers mid-range price,” and include these tags in the prompt sentence. These tags are computed by rule-based or model-based classification on feature data. This step creates an additional layer of abstraction specifically designed for interaction with the generative AI model, which further reduces complexity inside the generative AI model and allows the system to control and interpret generated outputs more reliably.

Accordingly, by defining precise data structures, explicit feature transformations, a specialized prediction model architecture, and a structured interaction with a generative AI model, the server performs technical operations that improve the efficiency, accuracy, and scalability of computerized gift recommendation. The combination of prediction scoring, prompt sentence construction, generative text refinement, and feedback-based retraining provides a concrete implementation that goes beyond generic data processing and produces measurable improvements in system-level performance metrics, such as reduced latency, improved hit rate of accepted recommendations, and reduced communication workload between the server and the generative AI model.

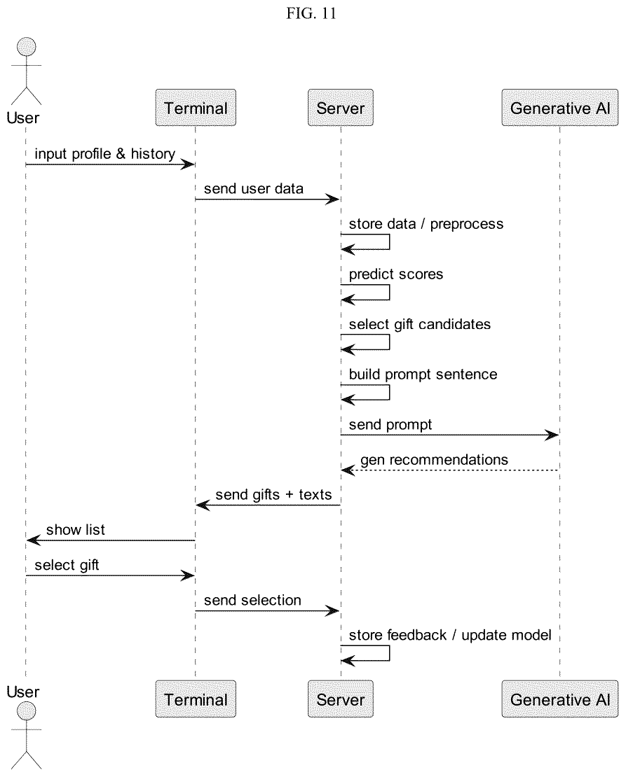

The following describes the processing flow using FIG. 11.

### Step 1:

The user operates the terminal to access an application provided by the server and to input user-related information and transaction history information.
The input is raw profile data (for example, age category, gender category, preference field category, occupation category, purchased item category) and raw history data (for example, item identifiers, categories, timestamps, and prices).
The terminal displays input fields, validates formats (for example, that required selections are made and numeric fields contain digits), and transmits the validated data as a structured message to the server through a communication network.
The output of this step is a structured request payload containing user-related information and transaction history information sent from the terminal to the server.

### Step 2:

The server receives the structured request payload from the terminal and stores the included user-related information and transaction history information in a storage device.
The input is the structured message containing user identifiers, profile attributes, and transaction records.
The server parses the message, extracts field values, maps them into internal data structures, and writes them into database tables, such as a user table and a transaction table, using indexed keys.
The output of this step is a set of persisted records in the storage device representing the user-related information and the transaction history information in a normalized database schema.

### Step 3:

The server performs preprocessing on the stored user-related information and transaction history information to generate feature data suitable for model computation.
The input is raw database records for one or more users and associated transaction entries.
The server loads these records into memory, detects missing values, replaces missing values using predetermined rules (for example, substituting a median or modal category), normalizes numerical attributes (for example, scaling purchase counts and price values), and converts categorical attributes into numerical vectors (for example, by indexing categories and creating one-hot or embedding indices).
The output of this step is a set of feature vectors for users and items stored in a feature table or a feature store, each vector representing a machine-readable encoding of user characteristics and interaction patterns.

### Step 4:

The server aggregates and augments the feature vectors to incorporate behavior-based statistics for each user.
The input is preliminary feature vectors and transaction history records.
The server computes aggregate statistics such as purchase frequency per category, recency of last purchase, average spending per transaction, and diversity measures over purchased categories, and then appends these statistics to the existing feature vectors.
The output of this step is an enhanced feature dataset, in which each user is represented by a high-dimensional vector that combines demographic, categorical, and behavioral attributes.

### Step 5:

The server trains a prediction model using the enhanced feature dataset and past preference or purchase labels.
The input is pairs of user feature vectors and item feature vectors together with labels indicating whether the user previously selected or purchased the item.
The server initializes a neural network or other learning model, defines a loss function (for example, logistic loss), and executes iterative optimization using gradient-based methods to adjust model parameters so that predicted scores approximate the historical labels.
The output of this step is a trained prediction model stored in the storage device, including learned weight matrices, bias vectors, and configuration metadata.

### Step 6:

The server reconstructs the trained prediction model in memory and prepares it for inference on new data.
The input is the stored model parameters and configuration metadata.
The server allocates memory structures for each layer of the model, loads weight and bias values, restores normalization parameters, and establishes an inference pipeline that will apply matrix multiplications and activation functions in the correct sequence.
The output of this step is an initialized, in-memory prediction model instance ready to receive user and item feature vectors and generate evaluation values.

### Step 7:

The server generates evaluation values for candidate items for a specific user using the prediction model.
The input is a target user's feature vector and a set of feature vectors for candidate items retrieved from an item catalog.
The server constructs combined input tensors by concatenating the user feature vector with each item feature vector, feeds these tensors through the prediction model, and computes scalar outputs representing degrees of preference for each candidate item.
The output of this step is a list of evaluation values associated with corresponding candidate item identifiers.

### Step 8:

The server ranks the candidate items and selects a group of gift candidate items based on the evaluation values.
The input is the list of candidate item identifiers and their evaluation values.
The server sorts the candidate items in descending order of evaluation value, optionally filters out items that do not satisfy constraints (for example, price range or category restrictions), and selects the top-ranked items as gift candidate items.
The output of this step is a ranked group of gift candidate items, each associated with an identifier, evaluation value, and basic item attributes.

### Step 9:

The server constructs profile information and item descriptions to be embedded into a prompt sentence for a generative AI model.
The input is the user-related information (for example, age category, gender category, preference field category, occupation category, purchased item category) and the ranked group of gift candidate items with item attributes.
The server converts categorical codes into human-readable phrases, formats item names, function summaries, and price ranges into concise text segments, and combines these segments into structured profile and item description strings.
The output of this step is a set of textual segments representing user profile information and candidate item descriptions.

### Step 10:

The server generates a prompt sentence for a generative AI model by combining the profile information and the candidate item descriptions according to a predetermined template.
The input is the profile text and item description text segments generated in the previous step.
The server inserts the profile description and a numbered list of candidate items into a template that specifies instructions to the generative AI model, such as requesting recommendation messages and explanations, while preserving a consistent syntactic structure.
The output of this step is a complete prompt sentence that encodes both user characteristics and ranked gift candidate items in natural language.

### Step 11:

The server transmits the prompt sentence to a generative AI model and obtains generated text as a response.
The input is the prompt sentence and configuration parameters such as maximum output length and sampling strategy.
The server calls an application programming interface of the generative AI model, sends the prompt sentence over a communication channel, waits for the model to process the input, and receives the generated text that includes recommendation sentences and explanation sentences for each gift candidate item.
The output of this step is the generated text content produced by the generative AI model in response to the prompt sentence.

### Step 12:

The server parses the generated text and associates recommendation information with corresponding gift candidate items.
The input is the generated text and the list of gift candidate items used in the prompt.
The server analyzes the text structure, identifies segments corresponding to each numbered item or label, extracts recommendation and explanation sentences, and maps each segment back to the item identifier using the numbering scheme embedded in the prompt.
The output of this step is a structured dataset in which each gift candidate item is linked to its recommendation sentence and explanation sentence.

### Step 13:

The server prepares a response message for the terminal that includes the gift candidate items, evaluation values, and generated recommendation information.
The input is the structured dataset from the previous step and any additional display attributes needed by the terminal, such as image URLs and price details.
The server constructs a response payload that encapsulates item identifiers, names, prices, evaluation scores, recommendation sentences, and explanation sentences, formatted according to a predefined data schema for the terminal.
The output of this step is a response message ready to be sent to the terminal.

### Step 14:

The server transmits the response message to the terminal via the communication network.
The input is the prepared response payload and network addressing information for the terminal.
The server opens a network connection or uses an existing session, sends the payload reliably using a communication protocol, and confirms successful transfer or retries on failure according to network control logic.
The output of this step is a delivered message at the terminal side that contains all necessary data to present recommended gifts to the user.

### Step 15:

The terminal receives the response message and displays the group of gift candidate items with associated recommendation information to the user.
The input is the response payload transmitted by the server.
The terminal parses the payload, builds internal data objects for each gift candidate item, and renders a user interface listing the items, showing names, images, prices, evaluation scores, recommendation sentences, and explanation sentences in a structured layout.
The output of this step is a visual presentation on the display device, enabling the user to review the recommended gift options.

### Step 16:

The user reviews the displayed gift candidate items and selects one or more items using the input interface of the terminal.
The input is the list of displayed items and the user's interaction, such as tapping or clicking selection controls.
The terminal records selected item identifiers and any additional user inputs, such as confirmation or comments, and packages this information into a structured selection message.
The output of this step is a selection message that represents the user's choice of gift candidate items.

### Step 17:

The terminal transmits the selection message to the server so that the user's selection result can be processed and stored.
The input is the structured selection message created in the previous step.
The terminal establishes or reuses a communication session with the server, sends the selection message, and awaits an acknowledgment to confirm that the server has received the selection result.
The output of this step is a successfully delivered selection message at the server side.

### Step 18:

The server receives the selection message and stores the selection result as part of the transaction history information or feedback information.
The input is the selection message containing the user identifier and selected item identifiers.
The server writes new records to a transaction or feedback table, linking the user to the selected items with timestamps and optional attributes, and updates aggregate statistics or counters in the user feature data to reflect the new selection.
The output of this step is updated database records that incorporate the latest user selection result.

### Step 19:

The server uses the stored selection results as learning data for retraining or updating the prediction model.
The input is a collection of accumulated selection records and corresponding historical feature data.
The server periodically constructs new training samples based on this updated data, recalculates gradients of the loss function, and adjusts the prediction model's weights to better align predicted evaluation values with actual selections, optionally updating normalization parameters and regularization terms.
The output of this step is an updated prediction model that captures recent user behavior patterns and improves the quality of future evaluation values and gift candidate rankings.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional gift recommendation systems generally rely on fixed rule sets, simple collaborative filtering, or static machine learning models that operate on coarse user segments. As a result, such systems typically exhibit several technical limitations. First, these systems often process user attribute information and electronic commerce history information in a fragmented manner, without constructing a unified feature representation that can be efficiently consumed by an advanced generative model. This leads to suboptimal utilization of available data and poor adaptability to changes in user behavior.

Second, in many existing architectures, natural language prompts for a generative artificial intelligence model, if used at all, are manually crafted or only loosely coupled to structured user data. The absence of a systematic mechanism to dynamically generate prompt sentences from updated user attribute information, electronic commerce history information, and contextual gift-giving conditions prevents the underlying model from accurately reflecting the current state of each user and the specific recommendation context. This results in generic or irrelevant outputs that do not fully exploit the capabilities of generative models.

Third, feedback from user terminal devices, such as which item was selected from a recommended product set and how the user evaluated that item, is often only used for superficial analytics or simple ranking adjustments. There is typically no integrated data flow that converts such feedback into structured training labels tied back to the original feature information and prompt sentences, and that then uses these labels to perform systematic retraining of the generative artificial intelligence model. Consequently, the model's generation accuracy does not improve in a continuous and data-driven manner.

From a computer technology perspective, these limitations manifest as inefficient data pipelines, weak coupling between structured feature representations and natural language prompts, and an absence of closed-loop learning between inference outputs and user feedback. This leads to increased computational waste, decreased model relevance, and a lack of scalability when adapting to diverse users and changing usage situations.

Accordingly, there is a need for a system and method that (i) automatically acquires and stores user attribute information and electronic commerce history information in a structured information storage structure, (ii) generates numerical feature information and corresponding natural language prompt sentences in a unified and machine-consumable form, (iii) drives a generative artificial intelligence model with these combined inputs to generate a product set tailored to gift-giving scenarios, and (iv) captures user selection result information and evaluation information as feedback information to perform systematic relearning of the generative artificial intelligence model. By technically integrating these components, computer resources can be used more effectively, and the accuracy and adaptability of gift candidate generation can be substantially improved over conventional systems.

The specific processing by the specific processing unit 290 of the data processing device 12 in Application Example 1 is realized by the following means.

The present invention provides a server comprising a processor configured to acquire user attribute information and electronic commerce history information, manage an information storage structure for storing the user attribute information and the electronic commerce history information, generate feature information composed of numerical information based on the user attribute information and the electronic commerce history information, construct a learning information set by associating the feature information with the user attribute information and the electronic commerce history information, construct and store a generative artificial intelligence model based on the learning information set, generate a prompt sentence as a natural language sentence including a description of the user attribute information and the electronic commerce history information together with gift-giving context information, form input information to the generative artificial intelligence model by combining the prompt sentence and the feature information, cause the generative artificial intelligence model to generate gift candidate information and specify a product set based on the gift candidate information, transmit the product set to a user terminal device, store in the information storage structure feedback information including selection result information and evaluation information acquired from the user terminal device, and perform relearning of the generative artificial intelligence model based on the feedback information and the learning information set to update parameter information of the generative artificial intelligence model. This enables an integrated, computer-implemented pipeline in which structured user data and dynamically generated prompt sentences are jointly exploited to drive a generative artificial intelligence model, and in which user feedback is converted into training signals for continuous model relearning, thereby improving the technical performance, accuracy, and adaptability of automated gift recommendation processing.

The term “user attribute information” refers to information indicating characteristics of a user, including at least one of demographic information, preference information, behavioral tendency information, and occupation-related information, which is used by a computer system as structured data for modeling the user.

The term “electronic commerce history information” refers to information indicating records of transactions performed by a user through an electronic commerce platform, including at least one of product identification information, product category information, transaction date and time information, quantity information, and price information, which is stored and processed by a computer system.

The term “information storage structure” refers to a logical data management structure implemented by a computer system, including at least one of a database, a data table, a data file, and a data repository, configured to store, retrieve, and update user attribute information, electronic commerce history information, feature information, and feedback information.

The term “feature information” refers to numerical or symbolic information generated from raw data including user attribute information and electronic commerce history information, the numerical or symbolic information being configured as machine-processable representation suitable for input to a computational model including a generative artificial intelligence model.

The term “learning information set” refers to an organized collection of data items including at least feature information and associated label information or context information, which is used by a computer system as training data for constructing or updating a generative artificial intelligence model.

The term “generative artificial intelligence model” refers to an information processing model implemented by software and executed by hardware, the information processing model being trained using machine learning or deep learning techniques to generate output information including at least text information or item candidate information in response to input information including feature information and a prompt sentence.

The term “prompt sentence” refers to a sequence of natural language expressions generated or selected by a computer system, the sequence including at least one of user attribute information, electronic commerce history information, and context information, and being used as an instruction or condition input to a generative artificial intelligence model.

The term “usage situation information” refers to information indicating a current or intended use case of a recommendation, including at least one of event information, time information, recipient-type information, and preference-context information, which is incorporated into a prompt sentence.

The term “gift-giving scene information” refers to information describing a situation in which a gift is to be provided, including at least one of a celebration type, a relationship category between giver and recipient, and a temporal context, which is used to condition generation of gift candidate information.

The term “gift target information” refers to information indicating at least one of a recipient profile, a gift purpose, and gift constraints such as budget and category, which is used by a computer system to guide generation of gift candidate information.

The term “gift candidate information” refers to information output from a generative artificial intelligence model, including at least one of item description information, item category information, and attribute information, which represents one or more candidates for a gift to be recommended to a user.

The term “product set” refers to a collection of product information items determined based on gift candidate information, each product information item including at least product identification information, product description information, and commerce-related information, the collection being configured for presentation to a user via a user terminal device.

The term “user terminal device” refers to an electronic data processing device operated by a user, including at least one of a mobile communication device, a portable information processing device, and a stationary information processing device, configured to send information to and receive information from a server via a communication network.

The term “selection result information” refers to information indicating at least one product selected or not selected by a user from a product set displayed on a user terminal device, the information including at least product identification information and selection status information.

The term “evaluation information” refers to information indicating an assessment by a user of at least one recommended product or recommendation result, including at least one of rating scale information, preference score information, and comment information, which is used as feedback information for model updating.

The term “feedback information” refers to information obtained from a user terminal device in response to presentation of a product set, including at least selection result information and evaluation information, the information being stored and used as training signals for relearning a generative artificial intelligence model.

The term “parameter information of the generative artificial intelligence model” refers to internal numerical values, including at least weight values and bias values, which define the functional behavior of the generative artificial intelligence model and are updated through a learning or relearning process.

The term “relearning” refers to a process executed by a computer system to adjust parameter information of a generative artificial intelligence model by using additional training data, including at least feedback information and a learning information set, after an initial training has been completed.

In one embodiment, a server cooperates with at least one terminal operated by a user to implement a recommendation system that generates and refines gift candidates using a generative AI model driven by structured feature information and a dynamically constructed prompt sentence. The server and the terminal are realized by general-purpose computing hardware, such as a central processing unit (CPU), a graphics processing unit (GPU), a main memory, a non-volatile storage device, and a network interface. The server executes an operating system such as a general-purpose server operating system and application software implemented, for example, in Python using libraries including a numerical computation library, a data frame processing library, and a deep learning framework such as TensorFlow or PyTorch. The terminal executes a client application implemented as a mobile application or a web application, running on a mobile operating system or a desktop operating system.

The server manages an information storage structure implemented as at least one database, for example a relational database such as a structured query database, or a key-value store. The server stores, in the information storage structure, user attribute information, electronic commerce history information, feature information, learning information sets, and feedback information. The server defines explicit data schemas for these categories. For example, a user attribute table includes fields for a user identifier, age, gender, occupation type, and preference tags. An electronic commerce history table includes fields for transaction identifier, user identifier, product identifier, product category code, transaction timestamp, quantity, and price. A feature table includes a dense vector representation (for example, a fixed-length array of floating-point numbers) associated with each user identifier. A feedback table includes a recommendation session identifier, user identifier, selected product identifier, rating value, and a timestamp.

The server converts the user attribute information and the electronic commerce history information into feature information by executing a feature generation program on the processor. The server uses software libraries such as a data frame processing library and a machine learning utilities library to perform operations including categorical encoding, normalization, aggregation, and sequence summarization. For instance, the server encodes categorical attributes (gender, occupation, main interest category) into integer indices and further into one-hot vectors or low-dimensional embeddings. The server aggregates electronic commerce history by computing, for each user, statistics such as counts of purchases per product category, recency-weighted purchase frequencies, and average basket value. The server normalizes numerical attributes including age and monetary values using min-max scaling or z-score normalization to improve numerical stability in subsequent neural network computations.

The server then constructs a fixed-length feature vector for each user by concatenating or otherwise combining the encoded user attribute information and the aggregated electronic commerce history information. In one example embodiment, the server constructs a 256-dimensional feature vector per user, where specific dimensions are reserved for demographic embeddings, purchase-category embeddings, temporal recency indicators, and budget profile indicators. The server stores these feature vectors in the information storage structure as binary or numerical fields associated with the user identifier. By defining such explicit feature vectors, the server reduces the dimensionality and redundancy of the raw data, enabling more efficient memory use and faster matrix operations on GPUs during training and inference.

The server constructs a generative AI model in the form of a neural network architecture that processes both feature information and a prompt sentence. In one embodiment, the server defines a transformer-based sequence model. The server uses the deep learning framework to implement: (i) an embedding layer for tokenized natural language inputs, (ii) an embedding layer or projection layer for feature vectors, (iii) a fusion mechanism to combine the two embeddings, and (iv) a stack of transformer encoder-decoder layers. The server configures multi-head self-attention sublayers, feed-forward sublayers, layer normalization, and residual connections according to known transformer architectures. The server defines model parameters, including weight matrices and bias vectors, as floating-point tensors storing values updated through a learning process.

The server trains the generative AI model using a learning information set that includes, for each training example, a feature vector for a particular user, a prompt sentence describing that user and a gift-giving context, and a target output sequence representing one or more historically successful gift descriptions or product category strings. The server tokenizes the prompt sentence and the target output using a tokenizer such as a subword tokenizer. The server computes an input token sequence for the prompt, an attention mask, and an associated feature vector. The server feeds this combined input into the neural network and obtains an output probability distribution over tokens at each position in the output sequence.

The server computes a loss function for training, such as a categorical cross-entropy between the predicted token distributions and the ground-truth target tokens. The server performs gradient-based optimization by executing backpropagation on the GPU using an optimizer such as Adam or another variant of stochastic gradient descent. The server updates the parameter information of the generative AI model (weight matrices and bias vectors) by subtracting gradients scaled by a learning rate. The server repeats this process over multiple epochs and mini-batches of the learning information set until a convergence criterion or a maximum epoch count is reached.

By integrating the structured feature vectors and the prompt sentences at the model input level, the server causes the model to learn correlations not only between text tokens but also between numerical behavior patterns and textual descriptions. This design improves the model's ability to generate contextually relevant gift candidates, and it does so in a way that is not achievable by manual rules or simple collaborative filtering methods. The server thereby improves the internal computational efficiency and accuracy of the recommendation process, since the feature vectors allow the model to focus attention on compressed, semantically rich representations of user behavior.

The server also generates a prompt sentence for inference that reflects current user attribute information, the most recent electronic commerce history, and a specific gift-giving context. The server composes the prompt sentence in natural language by concatenating structured elements, such as:
“The user is a 32-year-old female office worker who is highly interested in fashion and travel, and who frequently buys dresses, handbags, and accessories online. Please propose the most suitable birthday gift for this user.”

Alternatively, the server may generate prompt sentences such as:
“Propose three optimal gifts for a 30-year-old female user who often purchases dresses, handbags, and accessories online and is highly interested in fashion.”
or:
“Suggest several gift ideas for a 28-year-old male engineer who frequently buys gaming devices and PC peripherals as Christmas gifts.”

The server uses a deterministic formatting routine to ensure that specific fields (age, gender, main purchase categories, and event type) always appear in defined positions in the prompt sentence, which leads to more stable and reproducible model behavior. This structured prompt construction is a non-conventional use of natural language within a hybrid numerical-text model input, contributing to technical improvements in generation stability and accuracy.

The server causes the generative AI model to perform inference by supplying the tokenized prompt sentence and the associated feature vector as input. The server executes a sequence generation algorithm such as beam search, top-k sampling, or nucleus sampling (top-p) to generate output tokens representing gift candidate information. The server configures beam width, temperature, and sampling thresholds to control diversity and relevance. For example, the server may use a beam width of 5 and a temperature less than 1.0 to prioritize more likely candidates while still exploring diverse options. The server then decodes the output tokens into natural language strings containing gift descriptions or product category sequences.

The server post-processes the generated gift candidate information by parsing the strings, for example using pattern matching, token classification, or a secondary lightweight classifier, to extract structured product type and attribute information (such as “necklace,” “handbag,” “boots,” “color,” “material,” or “price range”). The server queries a product catalog database or an electronic commerce platform interface to map these extracted descriptors to concrete products that are currently available. The server filters the candidate products by availability, inventory status, and price constraints derived from the user's historical spending and optional user-specified budgets. The server then ranks the product set using a ranking function that combines scores from the generative model (e.g., log-likelihood or attention-based relevance) with additional relevance features derived from the user's purchase patterns and recent feedback signals. This ranking computation is executed by the processor as a series of vector operations and scoring functions, which can be further optimized using efficient numerical libraries.

The server transmits the ranked product set to the terminal via a communication network using a structured response format. The terminal receives the product set and renders it on a display device as a list or grid of recommended items, including product images, names, prices, and descriptions. The terminal allows the user to browse, select, and evaluate the recommended items. When the user selects one or more products from the displayed product set, the terminal sends selection result information and optional evaluation information (e.g., a rating on a numerical scale or a short comment) back to the server.

The server stores the selection result information and the evaluation information as feedback information in the feedback table in the information storage structure. The server associates each feedback record with the corresponding user identifier, feature vector, prompt sentence used for that recommendation, and generated gift candidate information. The server thereby constructs a closed-loop data flow in which the outputs of the model and the user's responses are captured in a structured form for subsequent retraining.

The server performs relearning of the generative AI model by using the stored feedback information in combination with the original learning information set. The server interprets positive feedback (e.g., high ratings, frequent selection) as positive labels and negative feedback (e.g., low ratings, no selection over repeated presentations) as negative labels. The server then constructs additional training examples where the target sequences emphasize positively evaluated gifts and de-emphasize negatively evaluated ones. The server may assign different loss weights to training examples based on the feedback strength, such that gifts rated highly by users have a larger impact on weight updates. This weighted learning strategy modifies the error function to better reflect the user's true preferences, reducing prediction error over time.

The server executes the retraining process periodically or in response to a triggered condition (such as accumulation of a threshold number of feedback records). During relearning, the server uses a smaller learning rate and may perform fine-tuning on the last few layers of the model to preserve previously acquired knowledge while incorporating new user behavior patterns. The server can also apply regularization techniques, such as dropout or weight decay, to prevent overfitting to a small subset of recent feedback. The server monitors validation metrics, including top-k recommendation accuracy and mean rating prediction error, to ensure that relearning leads to actual improvements.

Because the server maintains explicit feature vectors, prompt templates, and structured feedback records, the server can reuse previously computed feature vectors across multiple recommendation sessions without recomputing them from raw data each time. This reuse reduces CPU load, memory bandwidth consumption, and overall latency. Additionally, because the server performs inference and training on GPU hardware, the server achieves higher throughput for matrix multiplications and attention computations in the neural network, which directly improves processing speed compared to conventional CPU-only recommendation logic.

From a technical viewpoint, the described system improves the functioning of the computer itself in several ways. The server reduces required storage and communication volume by storing dense feature vectors instead of repeatedly transmitting and processing raw historical transaction records. The server improves computational efficiency by structuring feature vectors and prompt sentences so that the generative AI model can exploit attention mechanisms on compressed representations rather than on unstructured logs. The server improves data management by maintaining a unified information storage structure that links user attributes, commerce history, generated prompts, model outputs, and feedback in a consistent schema, which simplifies and accelerates subsequent data retrieval and retraining operations.

Furthermore, the server implements a non-conventional combination of numerical feature inputs and natural language prompt inputs in a single generative AI model, and this combination is integrated with a closed-loop feedback mechanism. This architecture is different from merely automating human gift selection tasks. The server uses internal numerical optimization, advanced neural attention architectures, and structured feedback-based updates to reduce error rates and to adaptively reconfigure the internal parameter space of the model in response to changing user behavior. As a result, the server not only replicates human decision-making but extends it by systematically processing large-scale data that cannot be managed by manual approaches, thereby enhancing accuracy, speed, and consistency in gift recommendation tasks.

In alternative embodiments, the server may employ different model architectures while maintaining the same general data flow. For example, the server may use a sequence-to-sequence recurrent neural network with gated recurrent units or long short-term memory units instead of a transformer, or may use a hybrid model in which a feed-forward neural network first transforms the feature vector into an embedding that is then concatenated to the prompt token embeddings. The server may also adjust the dimensionality of feature vectors, the number of attention heads, or the depth of the neural network layers according to resource constraints.

In another embodiment, the server may partition the feature information into multiple sub-vectors corresponding to different domains, such as demographic sub-features, purchase-frequency sub-features, and temporal sub-features. The server may then apply separate projection layers to each sub-vector and combine them using learned weighting coefficients before feeding them into the generative model. This configuration can further improve interpretability and optimization behavior, resulting in faster convergence and better accuracy.

In still another embodiment, the server may apply data augmentation techniques to the learning information set. For example, the server may generate synthetic prompt sentences by paraphrasing existing prompts using a secondary language model, or by randomly varying non-critical phrasing while preserving key structured fields. The server may also augment feature vectors by adding small noise to continuous components or by simulating missing data cases. These variations help the generative AI model to generalize better and to remain robust to slight changes in input.

The terminal may be configured in different forms, including a smartphone, a tablet, a laptop computer, or a stationary computer equipped with a display, input devices, and a network interface. The user interacts with the terminal via a graphical user interface composed of interactive elements such as buttons, lists, and rating controls. The terminal may locally cache some feature information or previously received product sets to reduce communication load and accelerate screen rendering. In some embodiments, the terminal may also pre-process user input, for example by locally validating fields or summarizing recent user browsing activities into compact signals sent to the server.

In each of these embodiments, the server remains responsible for the core technical operations, namely: managing the structured data storage, generating and updating the feature vectors, dynamically constructing prompt sentences, executing the generative AI model on specialized hardware, and applying a structured feedback-based relearning algorithm. Because these operations are implemented as specific sequences of data transformations and numerical optimizations, they provide concrete technical improvements in processing speed, recommendation accuracy, data management, and resource utilization, and thus realize the invention in a manner that can be practiced by one skilled in the art using the disclosed components and processing flows.

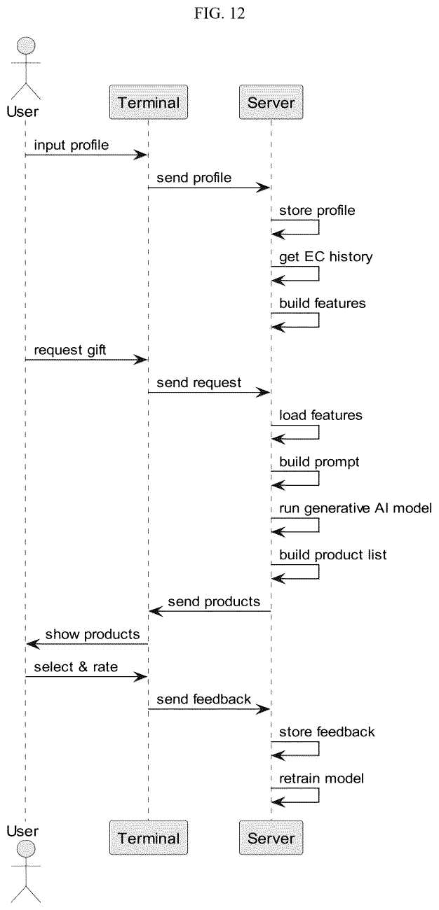

The following describes the processing flow using FIG. 12.

### Step 1:

The user operates the terminal to input user attribute information.
The terminal displays input fields for age, gender, occupation, and interests, and the user enters values such as “32,” “female,” “office worker,” and “fashion, travel.”
The terminal uses the entered values as input, constructs a structured data record, and outputs a data object containing user attribute information.

### Step 2:

The terminal transmits the user attribute information to the server.
The terminal takes the data object containing the user attribute information as input, serializes it into a request message, and sends the request to the server over a communication network.
The terminal outputs a network packet including the user attribute information as payload.

### Step 3:

The server receives and stores the user attribute information.
The server uses the network packet containing the user attribute information as input, parses the payload, and validates each field (for example, checking that age is numeric and gender is within a predefined set).
The server then executes a database insertion or update operation and outputs a stored record in an information storage structure that links a user identifier to the corresponding user attribute information.

### Step 4:

The server acquires electronic commerce history information associated with the user.
The server uses the user identifier as input and sends a request to an external commerce interface or an internal transaction log to obtain purchase records.
The server receives transaction data including product identifiers, categories, timestamps, quantities, and prices, and outputs normalized electronic commerce history information linked to the user identifier in the information storage structure.

### Step 5:

The server generates feature information from the user attribute information and the electronic commerce history information.
The server uses, as input, the stored user attribute record and the stored electronic commerce history records for the user.
The server converts categorical values into numerical indices, aggregates purchase counts by product category, normalizes numerical fields such as age and total spending, and concatenates these processed values into a fixed-length vector.
The server outputs feature information in the form of a numerical feature vector associated with the user identifier.

### Step 6:

The server constructs or updates a learning information set.
The server uses the feature vector, the original user attribute information, and the electronic commerce history information as input.
The server associates these data elements into a unified training sample structure, optionally including historical target outputs such as previously successful gift items.
The server outputs a learning information set comprising multiple such training samples stored in the information storage structure.

### Step 7:

The server trains or retrains the generative AI model using the learning information set.
The server uses the learning information set as input and feeds batched feature vectors and associated target text sequences into a neural network implemented, for example, with TensorFlow or PyTorch.
The server computes prediction errors using a loss function such as cross-entropy, propagates gradients backward through the network, and updates weight parameters using an optimization algorithm.
The server outputs updated parameter information and a trained generative AI model stored in a model repository.

### Step 8:

The user initiates a gift recommendation request on the terminal.
The user operates a user interface on the terminal to specify a gift-giving context such as “birthday gift” or “Christmas gift.”
The terminal uses the user identifier and the context string as input and constructs a request message for recommendation.
The terminal outputs a recommendation request packet addressed to the server.

### Step 9:

The server retrieves the current feature information and contextual data for the recommendation.
The server uses the recommendation request packet containing the user identifier and context string as input, queries the information storage structure to obtain the latest feature vector and user attribute information, and combines them with the context string.
The server outputs an internal data structure that includes the feature vector, user description, and gift-giving context.

### Step 10:

The server generates a prompt sentence for the generative AI model.
The server uses the internal data structure containing user-specific data and the gift-giving context as input and formats a natural language sentence that describes the user and the desired recommendation.
For example, the server generates a prompt sentence such as:
“The user is a 32-year-old female office worker who is highly interested in fashion and travel, and who frequently buys dresses, handbags, and accessories online. Please propose the most suitable birthday gift for this user.”
The server outputs the constructed prompt sentence as a text string associated with the user's feature vector.

### Step 11:

The server prepares combined input data for the generative AI model.
The server uses the prompt sentence and the feature vector as input, tokenizes the prompt sentence into tokens, and embeds both the tokens and the numerical feature vector into a joint representation compatible with the neural network architecture.
The server outputs a model input structure consisting of token indices, attention masks, and embedded feature values.

### Step 12:

The server executes inference using the generative AI model.
The server uses the model input structure as input and performs a forward pass through the trained generative AI model on hardware such as a GPU.
The server computes token probability distributions at each decoding step, applies a decoding strategy such as beam search or top-k sampling, and generates a sequence of output tokens representing gift candidate information.
The server outputs a natural language string containing generated gift descriptions, for example “a minimalist gold necklace, a designer leather handbag, and a pair of high-quality ankle boots.”

### Step 13:

The server converts the generated gift candidate information into a concrete product set.
The server uses the generated gift descriptions as input, parses them to identify product types and attributes such as category, style, or price range, and queries a product catalog in the information storage structure or via a commerce interface.
The server filters products based on availability and constraints, ranks products according to relevance scores derived from both the model output and user-specific statistics, and constructs a list of product entries.
The server outputs a product set including product identifiers, names, images, and prices.

### Step 14:

The server transmits the product set to the terminal.
The server uses the constructed product set as input, serializes it into a response message, and sends it over the communication network to the terminal associated with the user.
The server outputs a network packet containing the ranked product set as payload.

### Step 15:

The terminal displays the recommended product set to the user.
The terminal uses the received product set as input, parses the product entries, and renders them on a display as a list or grid of recommended items, each showing an image, a title, and a price.
The terminal outputs a graphical user interface that allows the user to review the recommended gifts.

### Step 16:

The user selects one or more products and provides evaluation information.
The user interacts with the displayed interface on the terminal, for example by tapping a specific product to select it and assigning a rating such as “5 stars” or entering a short comment.
The terminal uses the selected product identifier and the evaluation value as input and constructs feedback data.
The terminal outputs a feedback message sent to the server.

### Step 17:

The server stores the feedback information.
The server uses the feedback message containing the user identifier, selected product identifier, rating, and any comment as input, validates the fields, and associates the feedback with the corresponding recommendation session, feature vector, and prompt sentence in the information storage structure.
The server writes a new record into a feedback table and outputs an updated feedback dataset linked to the learning information set.

### Step 18:

The server generates relearning data from the feedback information.
The server uses the feedback dataset and the existing learning information set as input, labels training examples according to positive or negative evaluations, and constructs new training samples where highly rated products are emphasized in the target outputs.
The server may assign higher weight values to samples corresponding to strong positive feedback and lower weight values to samples with neutral or negative feedback.
The server outputs an augmented learning information set that incorporates user feedback.

### Step 19:

The server performs relearning of the generative AI model.
The server uses the augmented learning information set as input and executes a fine-tuning process on the generative AI model, recomputing gradients and updating selected model parameters with a controlled learning rate.
The server adjusts weights and biases in the model to reduce the loss for feedback-informed samples, thereby shifting the model's output distribution toward items that users have preferred.
The server outputs an updated generative AI model with improved parameters for subsequent recommendation sessions.

### Step 20:

The server deploys the updated generative AI model for future requests.
The server uses the updated model parameters as input, replaces or versions the model instance used for inference on the server, and ensures that new recommendation requests from terminals are processed by the updated model.
The server outputs an operational model configuration that provides enhanced generation accuracy and responsiveness to user preferences in future executions of the gift recommendation flow.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented recommendation systems for gifts typically rely on static rule sets or pre-defined questionnaires that are manually designed and rarely adapted in real time to the user's intent. Such systems often require engineers or operators to curate question flows and decision trees, which leads to rigid interaction patterns that do not adequately capture nuanced user needs or the context of a specific gifting scenario. As a result, the underlying computing resources are not effectively utilized to refine query conditions, and the quality of search queries against product databases remains limited, causing inefficient use of storage and processing resources in backend systems.

In addition, conventional systems treat user attribute information, transaction history information, and user-provided natural language requests as independent data streams, without integrating them into a unified context when generating intermediate interaction steps. This lack of integrated context leads to suboptimal prompt generation for any downstream language-processing modules and prevents the system from asking the most informative follow-up questions. Consequently, the computing system performs repeated or unnecessary queries to product databases, increases network traffic, and incurs additional computational overhead, while still failing to narrow down gift candidates effectively.

Furthermore, existing systems that do incorporate language models often use such models only at the final recommendation stage, and not for dynamically constructing query-refining questions. In those architectures, the processor must perform additional pre-processing and post-processing steps around the language model, which increases latency and complexity. The absence of a structured way to embed session state, user attributes, and transaction history into a prompt for a generative AI model makes it difficult for the computer system to systematically control the number, format, and content types of generated questions. This lack of control reduces the predictability and efficiency of the interaction loop between the user interface, the generative model, and the product search subsystem.

Accordingly, there is a need for an improved computer-implemented technique that uses a processor to (i) integrate user attribute information, transaction history information, and natural language request sentences as context information, (ii) automatically construct prompt sentences for a generative AI model with explicit instruction information regarding question generation, (iii) obtain structured question sentences tailored to a gifting scenario, (iv) normalize user answers into machine-usable attribute and budget conditions, and (v) drive efficient database search and ranking operations based on those conditions. By addressing these issues at the system architecture and data-flow level, the invention aims to reduce redundant computation, lower network and storage overhead, and improve the precision and responsiveness of computer-based gift recommendation processing.

The specific processing by the specific processing unit 290 of the data processing device 12 in Example 2 is realized by the following means.

The present invention provides a server comprising a processor configured to store user attribute information and transaction history information as data used for a learning process, acquire, via a terminal including a display device and an input device for dialog, a natural language request sentence from a user regarding a gifting purpose and receive dialog-start information including the request sentence, generate a prompt sentence to be input to a generative language model based on the request sentence and the user attribute information and the transaction history information, embed context information into the prompt sentence, add instruction information specifying a number, an expression format, and types of contents of question sentences regarding a gift recipient, and transmit the prompt sentence including the instruction information to the generative language model so as to cause the generative language model to generate the question sentences, obtain the question sentences from the generative language model and transmit the question sentences to the terminal, normalize user input acquired from the terminal as answers to the question sentences so as to extract attribute conditions and budget conditions of the gift recipient, issue a search request to a product information database based on the attribute conditions and the budget conditions, select gift candidates by scoring a plurality of product information items acquired from the product information database using a preference estimation result based on the user attribute information and the transaction history information, rank the gift candidates based on relevance scores, and transmit at least part of the ranked gift candidates to the terminal as proposal information for display on the terminal. This enables an improved computer-implemented gift recommendation process in which the processor systematically controls the behavior of the generative AI model through structured prompt sentences, efficiently converts user interactions into precise search conditions, reduces unnecessary database access and computation, and increases the relevance and responsiveness of recommendations while optimizing utilization of computing and storage resources.

The term “user attribute information” refers to information indicating characteristics of a user, including at least one of demographic data, preference-related data, and behavior-related data, which is stored and used by a processor for learning and recommendation processing.

The term “transaction history information” refers to information indicating past transactions associated with a user, including at least one of purchased items, purchase timestamps, purchase prices, categories, and interaction logs, which is stored and used by a processor for learning and recommendation processing.

The term “learning process” refers to a computational process executed by a processor in which stored data, including user attribute information and transaction history information, is used to train, update, or adapt a predictive model or scoring logic for estimating user preferences or relevance of items.

The term “terminal” refers to an information processing apparatus including at least a display device and an input device, such as a mobile device, a personal computer, or another client device, which is configured to present information to a user and accept input from the user in communication with a server.

The term “display device” refers to a hardware component of a terminal that visually presents information, including at least one of text, images, and graphical user interface elements, to a user.

The term “input device” refers to a hardware or software component of a terminal that accepts user input, including at least one of a keyboard, a touch panel, a pointing device, a microphone, or an on-screen input control.

The term “natural language request sentence” refers to a sentence or phrase expressed in a human language and input by a user to indicate an intent or requirement, including at least a request related to a gifting purpose.

The term “dialog-start information” refers to information indicating that a dialog session between a user and a server has been initiated, and including at least the natural language request sentence and optionally session identifiers or metadata.

The term “generative language model” refers to a trained computational model that receives a text input and generates text output by predicting subsequent tokens, and that is configured to produce natural language question sentences or other linguistic content in response to a prompt sentence.

The term “prompt sentence” refers to text data generated by a processor and provided as input to a generative language model, the text data including at least context information and instruction information for controlling generation of output text by the generative language model.

The term “context information” refers to information embedded into a prompt sentence that represents a situation or state related to a dialog, including at least the natural language request sentence, user attribute information, transaction history information, and optionally session-related data.

The term “instruction information” refers to control information included in or associated with a prompt sentence and specifying at least one of a number, an expression format, and types of contents of question sentences or other output to be generated by a generative language model.

The term “question sentence” refers to a sentence generated by a generative language model in response to a prompt sentence, the sentence being configured to inquire additional information from a user, including at least information regarding a gift recipient.

The term “gift recipient” refers to a person or entity that is intended to receive a gift, and whose characteristics are used as conditions in a recommendation process.

The term “user input” refers to data entered by a user via a terminal, including at least text input, numerical input, or speech-derived text, which is provided as answers to question sentences or as other interaction data.

The term “normalize” refers to a process executed by a processor that converts user input expressed in arbitrary natural language or format into standardized, machine-usable data, including at least structured attribute values and budget values.

The term “attribute conditions” refers to structured information derived from user input and representing characteristics of a gift recipient, including at least age, interests, and other profile-related attributes, which are used as conditions for searching a product information database.

The term “budget conditions” refers to structured information derived from user input and indicating at least a price or a price range for a gift, which is used as a condition for searching a product information database.

The term “product information database” refers to a data storage resource managed by a computer system and configured to store product information items, each product information item including at least identifiers, category data, price data, and descriptive data of products.

The term “search request” refers to a query or command issued by a processor to a product information database based on attribute conditions and budget conditions, the query or command being configured to retrieve a plurality of product information items that satisfy the conditions.

The term “product information item” refers to a record stored in a product information database and representing an individual product or service, including at least an identifier, descriptive fields, category fields, and price-related fields.

The term “gift candidate” refers to a product information item selected from among a plurality of product information items based on scoring or ranking processing, and deemed suitable as a recommendation for a gift recipient.

The term “preference estimation result” refers to an output of a learning process or predictive model that indicates an estimated degree of preference or suitability of a product information item for a user or a gift recipient, based on user attribute information and transaction history information.

The term “relevance score” refers to a numerical or ordered value calculated by a processor for each product information item, the value indicating a degree of relevance or suitability of the item with respect to a user, a gift recipient, or given conditions.

The term “proposal information” refers to information generated by a processor and transmitted to a terminal for presentation to a user, including at least identifiers, descriptions, and optionally prices or links related to selected gift candidates.

The term “session identification information” refers to information used by a processor to uniquely identify and manage a dialog session with a user, and to associate question sentences, user inputs, and recommendation results within the same session.

In one embodiment, a server cooperates with one or more terminals operated by users in order to provide gift recommendations using a generative AI model controlled by structured prompt sentences. The server includes at least one processor, a memory, a non-transitory storage device, a network interface, and access to a product information database. The terminal includes at least a display device, an input device, a communication module, and an execution environment for an application or browser. The user operates the terminal to interact with the server over a communication network such as the Internet.

The server executes an application program implemented, for example, on a generic server platform such as a virtual machine or container running on a cloud computing environment. The server uses an operating system, such as a general-purpose server operating system, and a web application framework such as a scripting runtime with a web framework or a compiled language framework. The server further uses a database management system, such as a relational database management system (RDBMS) or a NoSQL database service, to manage user attribute information, transaction history information, and product information items.

The terminal executes a client application, such as a mobile application implemented with a mobile application framework, or a web browser that runs an HTML/JavaScript-based user interface. The terminal uses a touch panel, a keyboard, or a microphone as the input device, and uses a liquid crystal display or organic light emitting diode display as the display device. The terminal uses a wireless communication module, such as a cellular communication module or a wireless local area network module, to communicate with the server via secure protocols such as HTTPS.

The server stores user attribute information and transaction history information in data structures optimized for recommendation processing. The server uses relational tables having columns for user identifiers, demographic fields (age range, region, etc.), interest tags, and behavioral statistics, as well as columns for product identifiers, purchase timestamps, prices, and category codes. In another embodiment, the server uses a key-value or document data store in which user profiles and transaction records are stored as documents with nested fields for attributes and historical events.

The server processes these stored data using a learning process implemented as a machine learning pipeline. The server uses a feature extraction module that converts user attribute information and transaction history information into numerical feature vectors. For example, the server maps categorical attributes such as age group or region into one-hot or embedding vectors, counts product category occurrences to construct frequency vectors, and computes recency scores for recent purchases. The server provides these feature vectors to a preference estimation model, which is implemented as, for example, a multi-layer neural network or a gradient boosting model. In a neural network embodiment, the server uses a feedforward neural network having an input layer corresponding to the feature dimensions, one or more hidden layers with non-linear activation functions such as ReLU, and an output layer providing a preference score for each product category or latent factor.

The server trains this preference estimation model using supervised learning on historical transaction data. The server uses a loss function such as cross-entropy loss or mean squared error between predicted preference scores and observed user behaviors (purchases, clicks). The server updates model weights by a gradient-based optimization algorithm such as stochastic gradient descent or Adam. The server may perform data augmentation by randomly reordering interactions or sub-sampling negative examples to stabilize training. The server stores the trained model parameters in the storage device and loads them into memory at runtime to perform real-time inference.

The server also cooperates with an external or internal generative AI model. In one embodiment, the server accesses a generative AI model provided as a network service implementing a transformer-based architecture. This architecture uses multi-head self-attention layers, positional encodings, and feedforward sublayers to process sequences of tokens and generate new tokens. The generative AI model receives a prompt sentence as a sequence of tokens and predicts subsequent tokens according to learned probability distributions. The server does not rely on the generative AI model to perform the entire recommendation, but instead configures the model via explicit prompt sentences to generate question sentences that refine the conditions used by the server for database search and ranking.

The server generates a prompt sentence using a prompt-generation module in the application program. The server constructs the prompt sentence using a predefined template and inserts context information, such as the user's natural language request, known user attributes, and aggregated transaction history. For example, when the user inputs “I am looking for a birthday present for my friend,” the server generates a prompt sentence such as:
“Role: You are an assistant that helps users choose gifts.
User request: ‘I am looking for a birthday present for my friend.’
Task: Generate three short follow-up questions to better understand the friend's profile and the user's constraints.
The questions should ask about 1) age, 2) hobbies or interests, and 3) budget.
Output only the questions, one per line.”

In another example, when the server already knows that the user previously purchased music-related items, the server embeds such context as:
“Context: The user previously purchased several music-related items and often buys items for people in their twenties.
User request: ‘I am looking for a birthday present for my friend.’
Task: Generate up to four short questions that ask about the friend's age group, favorite activities, and approximate spending limit, focusing on information useful for suggesting music-related or entertainment gifts.
Output only the questions, each as a single short sentence.”

The server generates these prompt sentences as plain text strings and sends them to the generative language model. The server sets control parameters, such as maximum output length and temperature, to obtain concise and deterministic question sentences. By embedding structured instruction information in the prompt sentence, the server constrains the generative model to generate a specific number, format, and type of questions. This reduces variability and facilitates downstream parsing.

The server parses the generated question sentences into structured records and associates each question with a session identifier. The server stores these records in a question table with columns for session ID, question ID, question text, expected answer type, and timestamp. The server then transmits the question texts to the terminal. The terminal renders the questions using a graphical user interface. The user reads the questions and inputs answers via text entry fields, numerical fields, sliders, or voice input.

The server receives user input from the terminal and executes a normalization module. The server converts free-form textual answers into standardized attribute conditions. For example, the server parses an answer such as “around 50 dollars” into a budget condition with a numeric center value and a range, and converts currency if necessary. The server parses an answer such as “She is 25 and loves indie music” into an age value and interest tags using natural language processing, including tokenization, part-of-speech tagging, and keyword extraction. The server maps the extracted terms to internal category codes in a taxonomy maintained in the product information database. This normalization process generates attribute conditions and budget conditions in a data structure that is directly usable as parameters for database queries and scoring functions.

The server then issues search requests to the product information database based on the attribute conditions and budget conditions. The server constructs a parameterized database query that filters products by conditions such as price range, category tags, and target age group. The server may use indexed columns on price and category to avoid full-table scans and thereby reduce input/output load and improve response time. In one embodiment, the server constructs an SQL query with WHERE clauses for age and price, and uses ORDER BY clauses on pre-computed popularity scores. In another embodiment, the server formulates a query expression for a document store, using filter expressions on JSON fields for tags and price.

The server receives a plurality of product information items satisfying the database filters and then computes a relevance score for each item using the preference estimation model described above. The server constructs a feature vector for each product-user pair, including product attributes (category embeddings, price buckets, popularity features) and user attributes (demographic embeddings, interest vectors, history-based statistics). The server feeds this feature vector into the neural network or other model to output a predicted preference score. The server combines this score with rule-based adjustments, such as penalizing items slightly above budget or boosting items matching specific declared interests (e.g., “music”), to yield a final composite relevance score.

The server sorts the product information items according to the composite relevance score and selects the top items as gift candidates. The server packages the selected items into proposal information that includes product identifiers, names, descriptions, images, prices, and purchase links. The server sends this proposal information to the terminal. The terminal displays the proposal information with appropriate layout, such as cards with images and buttons, allowing the user to inspect and select a gift.

The server improves computer technology in several ways. First, the server reduces computational load and network traffic by using the generative AI model not to directly produce recommendations, but to generate only a small number of high-information questions driven by prompt sentences enriched with context. This reduces the number of iterations needed to refine search conditions compared to static questionnaires, which often require many low-information questions. As a result, the server reduces the total number of database queries and API calls, lowering latency and conserving bandwidth.

Second, the server improves the accuracy and efficiency of data management by normalizing user answers into structured conditions directly correlated with database schema fields. Because the server designs the prompt sentences to elicit specific answer types (age, hobbies, budget), the normalization module can rely on constrained patterns and apply efficient parsing routines instead of general-purpose natural language understanding for arbitrary text. This yields better extraction accuracy with fewer processing steps and reduces error propagation into the recommendation pipeline.

Third, the server implements a specific data flow and module architecture that enhances computation efficiency and memory usage. The server maintains session state, question records, normalized conditions, and product features in separate but linked data structures in the database and in memory caches. The server reuses pre-computed embeddings and preference model outputs when similar feature vectors appear, reducing redundant computations. The design of the prompt-generation module, normalization module, and scoring module as individual components with defined interfaces allows the server to parallelize or pipeline processing steps internally, achieving lower end-to-end latency.

Fourth, the server operates the generative language model under explicit constraints encoded in the prompt sentence, combining generative modeling with deterministic control logic. This differs from merely automating human questioning patterns. The server uses machine-readable instruction information specifying number, expression format, and content types of output questions, which allows the server to predict the structure of the output and to parse it efficiently. This non-conventional integration of generative modeling with structured control leads to a technical improvement in how text-generation modules are orchestrated within a recommendation system.

Fifth, the server adapts the interaction in real time using internal signals such as estimated uncertainty of preference predictions or sparsity of candidate products. For example, when the server detects that candidate products in a price range are too numerous, the server can adjust the prompt sentence to request an additional constraint from the user, such as preferred product type or brand-neutral functional criteria. This dynamic adaptation reduces search space size in subsequent database queries, thereby decreasing processor time and input/output operations.

In another embodiment, the server deploys the preference estimation model and part of the normalization module on an edge node or local gateway device to further reduce network latency. In this configuration, the terminal may also perform certain normalization tasks, such as mapping currency or converting plain language age ranges (“mid-twenties”) to numeric ranges, and then send partly normalized conditions to the server. The server, in turn, retains responsibility for prompt generation, generative AI invocation, and product database access.

In a further embodiment, the server may use a different type of generative AI model, such as a sequence-to-sequence encoder-decoder network, but still constructs prompt sentences with embedded context and instruction information. The specific architecture (transformer, recurrent neural network, or hybrid) can be varied without departing from the core concept of using structured prompt sentences to guide question generation and then converting resulting user answers into structured database conditions.

The user primarily interacts with the system via the terminal, but the underlying improvements are in the way the server coordinates generative modeling, context embedding, normalization, and database operations. This coordination yields higher recommendation relevance and lower system load than traditional static questionnaires or simple rule-based search filters. Because the server performs these processes according to specific data structures, machine learning models, and prompt-control methods, the invention constitutes an improvement in computer-based recommendation technology rather than a mere automation of manual gift selection.

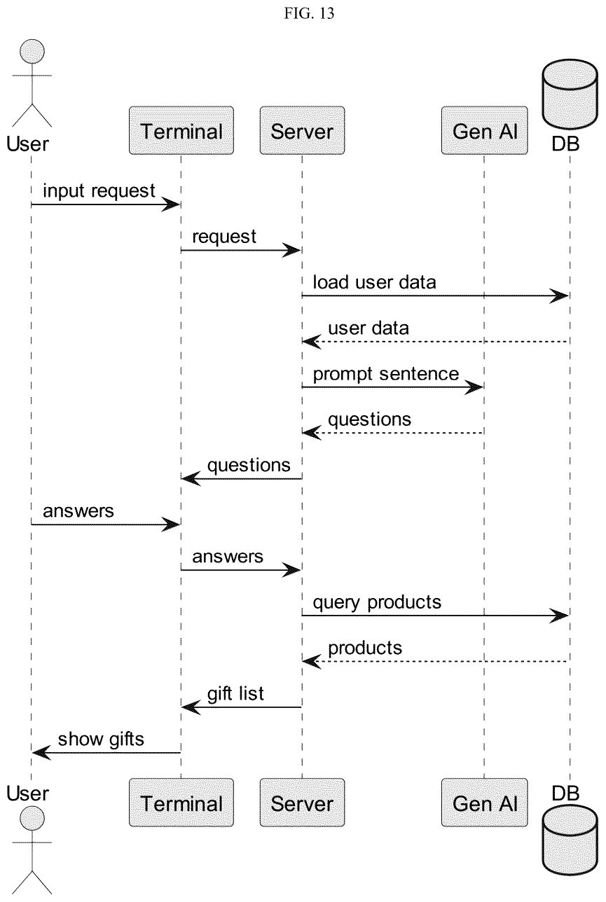

The following describes the processing flow using FIG. 13.

### Step 1:

User operates the terminal to launch an application or web page for gift recommendation.
User inputs a natural language request sentence, such as “I am looking for a birthday present for my friend,” using a keyboard, touch screen, or microphone.
Terminal, when receiving voice input, converts audio signals into text data using a speech recognition engine and stores the resulting character string in memory.
Terminal sets a session identifier, attaches device information and a timestamp, and constructs a request message in a structured format (for example, JSON) containing at least the request sentence and the session identifier as input.
Terminal transmits the request message to the server via a secure communication channel (HTTPS).
The input to this step is user-generated natural language content, and the output is a structured request message containing the request sentence and session metadata that can be processed by the server.

### Step 2:

Server receives the request message from the terminal through a network interface and passes the message to a web application module.
Server parses the structured request message, extracts the request sentence, session identifier, and any available user authentication information, and stores this data in a request log table in a database.
Server retrieves stored user attribute information and transaction history information associated with the user identifier from a user-profile datastore.
Server combines the extracted request sentence with the retrieved user attribute information and transaction history information to form context information used as input for subsequent processing.
The input to this step is the structured request message and stored user profile data, and the output is a context object containing the request sentence, user attributes, and transaction history, ready for prompt sentence generation.

### Step 3:

Server generates a prompt sentence for a generative AI model using the context object.
Server executes a prompt-generation routine that fills a predefined text template with elements from the context object, including the user's request sentence and summary statistics of user behavior (for example, common categories and price ranges).
Server embeds instruction information specifying the required number of questions, the expression format (short interrogative sentences), and the types of contents (age, hobbies, budget) into the same prompt sentence.
Server may generate a prompt sentence such as:
“Role: You are an assistant that helps users choose gifts.
User request: ‘I am looking for a birthday present for my friend.’
Task: Generate three short follow-up questions to better understand the friend's profile and the user's constraints.
The questions should ask about 1) age, 2) hobbies or interests, and 3) budget.
Output only the questions, one per line.”
Server stores the generated prompt sentence in a prompt log table linked to the session identifier.
The input to this step is the context object, and the output is a fully constructed prompt sentence text that can be transmitted to the generative AI model.

### Step 4:

Server sends the prompt sentence to a generative AI model via an application programming interface.
Server constructs an API request body including at least the prompt sentence, model identifier, and generation parameters such as maximum token length and randomness control parameters.
Server transmits this API request over a secure network connection to a model-hosting service.
Generative AI model processes the sequence of tokens representing the prompt sentence by applying multiple layers of self-attention and feedforward computations to estimate probability distributions for subsequent tokens.
Generative AI model generates question sentences, for example:
“What is your friend's age?
What are your friend's hobbies or interests?
What is your budget for the gift?”
Server receives the API response containing the generated text from the generative AI model.
Server extracts the generated question text and associates it with the original session identifier for further processing.
The input to this step is the prompt sentence text, and the output is one or more generated question sentences in natural language.

### Step 5:

Server parses the generated question sentences into a structured internal representation.
Server splits the returned text by line breaks or other delimiters to obtain individual question strings and trims leading and trailing whitespace.
Server assigns a question identifier to each question and determines an expected answer type (for example, numeric for age, free-text for hobbies, numeric or range for budget) based on matching patterns or preconfigured rules.
Server constructs question records containing fields such as session identifier, question identifier, question text, and expected answer type, and stores these records in a question table in a database.
Server creates a question payload, including the question texts and corresponding identifiers, and sends this payload to the terminal for display.
The input to this step is the raw generated question text, and the output is a structured question payload prepared for presentation to the user through the terminal.

### Step 6:

Terminal receives the question payload from the server through the network interface.
Terminal parses the payload to extract the list of question texts and question identifiers, and updates the user interface to display each question on the display device.
User reads the displayed question sentences and inputs answers through the input device.
User may enter “25” for an age question, “listening to music and going to concerts” for a hobbies question, and “around 50” for a budget question.
Terminal optionally provides input validation, for example checking that the age field contains numeric characters, and may prompt the user to correct invalid input.
Terminal constructs an answer message including the session identifier, each question identifier, and the corresponding user answer as input data.
Terminal transmits the answer message to the server via HTTPS.
The input to this step is the question payload and user interactions, and the output is a structured answer message containing user answers mapped to question identifiers.

### Step 7:

Server receives the answer message and passes it to an answer-normalization module.
Server validates the session identifier and retrieves the corresponding question records from the question table to confirm the expected answer types.
Server performs normalization and extraction computations on the raw answer strings.
Server converts an answer such as “25” or “25 years old” into an integer age value, maps “listening to music and going to concerts” into standardized interest tags, and interprets “around 50” into a numeric budget range such as a lower bound and an upper bound.
Server uses text-processing techniques such as tokenization, pattern matching, and dictionary lookup to recognize currency units and interest categories, and then maps them to internal category codes.
Server aggregates these normalized values into structured attribute conditions (for example, intended recipient age and interests) and budget conditions (for example, target price range).
Server stores the attribute conditions and budget conditions in a session state store or condition table in the database.
The input to this step is the answer message with raw user answers, and the output is a normalized condition object describing the gift recipient's attributes and budget constraints.

### Step 8:

Server constructs a database search request using the attribute conditions and budget conditions.
Server translates the conditions into query predicates suitable for the product information database schema, for example specifying a price BETWEEN range and category codes IN a set derived from interest tags.
Server formulates a query string or query object and includes ordering hints such as sorting by pre-computed popularity or rating scores.
Server sends this search request to the product information database using a database driver.
Product information database executes the query using indexes on price and category fields and returns a list of product information items that satisfy the conditions.
Server receives the result set and converts each record into an internal product representation containing attributes such as identifier, category, price, and descriptive text.
The input to this step is the normalized attribute and budget conditions, and the output is a candidate product list retrieved from the product information database.

### Step 9:

Server applies a scoring and ranking process to the candidate product list.
Server generates feature vectors for each candidate product by combining product attributes with user attribute information and transaction history information.
Server inputs these feature vectors into a preference estimation model, such as a trained neural network, to obtain predicted preference scores.
Server optionally incorporates rule-based adjustments to account for strict constraints, such as excluding items outside the exact budget range or boosting items matching explicit interest tags.
Server computes a composite relevance score for each product by combining model outputs and rule-based scores, and then sorts the candidate list in descending order of the composite relevance score.
Server selects a subset of top-ranked products as gift candidates and creates proposal information that includes user-facing details for each selected product.
The input to this step is the candidate product list and the user-related feature data, and the output is an ordered list of gift candidates with associated proposal information.

### Step 10:

Server transmits the proposal information to the terminal as a recommendation response message.
Terminal receives the response message, parses the list of gift candidates, and renders the result on the display device as a set of product cards or entries.
User views the displayed proposals and may select a particular gift candidate for more details or for purchase.
Terminal, upon user selection, may open a detailed view inside the application or launch a web browser to navigate to an external commerce site using the purchase link contained in the proposal information.
Terminal thus presents the output of the recommendation computation to the user in a form usable for making a real-world purchasing decision.
The input to this step is the ordered list of gift candidates produced by the server, and the output is a visual presentation on the terminal and further user actions based on the presented recommendations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented gift recommendation systems mainly rely on fixed rule sets or static collaborative filtering based on purchase history. Such systems suffer from several technical limitations when executing on general-purpose computing hardware.

First, conventional systems typically process user input as simple parameter fields (such as age, gender, and price range) and do not effectively utilize natural language inputs describing complex gift scenarios. As a result, the processor cannot dynamically determine what information is missing for a particular transaction context, and repeatedly forces the user to navigate rigid forms or menus. This leads to inefficient use of processor cycles and network resources, because the system often collects redundant information while still failing to obtain the most relevant missing data.

Second, conventional systems do not integrate a generative AI model into the core control flow of the recommendation engine in a structured manner. In many cases, a generative model, if used at all, is only called to produce superficial text, such as product descriptions, without controlling the sequence of information acquisition and recommendation refinement. This prevents the processor from adaptively generating prompt sentences that are optimized for different stages of the interaction, such as clarifying missing conditions, incorporating emotional factors, or generating anniversary-aware recommendations. As a result, the generative model is underutilized, and the system cannot effectively reduce the computational load associated with trial-and-error queries and manual prompt tuning.

Third, typical systems do not perform fine-grained emotion analysis that links both sender-side and recipient-side emotional states to the underlying data structures used for ranking candidate items. Even when user sentiment is detected, it is often stored as a loosely associated tag and is not tightly integrated into the algorithm that computes suitability scores for candidate items. Consequently, the processor cannot fully exploit emotional context as a first-class input to the recommendation algorithm, and must fall back on simpler heuristics. This reduces the precision of candidate ranking and forces the system to exchange larger result sets over the network, increasing latency and bandwidth consumption.

Fourth, many existing platforms treat reminder functionality and message generation as completely separate features. Reminder modules are often implemented as simple calendar alarms that are not connected to the recommendation engine. Likewise, message-generation modules, if present, typically use generic templates that do not leverage the same user context, transaction history, and emotions that inform the recommendation logic. This fragmented architecture leads to duplicated data flows, extra database queries, and inconsistent internal representations, which degrade system performance and make it more difficult for the processor to optimize resource usage across all tasks.

Fifth, conventional systems lack a feedback mechanism that records prompt sentences and generative AI responses in a structured history and uses that history to automatically refine the prompt generation and candidate-selection logic over time. Without this feedback loop, the system cannot adaptively learn which prompt structures or ranking conditions yield better user outcomes. As a result, each invocation of a generative AI model is effectively stateless, forcing the processor to repeatedly explore suboptimal prompt patterns and increasing overall computational cost per recommendation session.

Accordingly, there is a need for an improved computer-implemented system in which the processor coordinates collection and preprocessing of user and transaction data, dynamically generates and refines prompt sentences for a generative AI model, integrates emotion analysis into the core ranking logic, automatically triggers recommendation flows based on calendar events, and records interaction histories to continuously improve prompting and selection. By reorganizing how these components interact at the processor level, the system can reduce unnecessary computation and network traffic, improve the relevance and structure of the data delivered to and from the generative AI model, and thereby enhance the overall efficiency and technical performance of the recommendation platform executing on a computing apparatus.

The specific processing by the specific processing unit 290 of the data processing device 12 in Application Example 2 is realized by the following means.

The present invention provides a server comprising a processor configured to collect and preprocess attribute information and transaction history information regarding a user of the system, to store the collected information in a storage unit, to provide to a terminal device a user interface that enables the user or a gift recipient to input or update the attribute information and the transaction history information, to analyze a natural language gift request received from the terminal device in order to extract at least a gift purpose, a gift recipient, a budget range, and an auxiliary condition, and to identify missing information required for gift selection. This enables the processor to convert unstructured text requests into a structured context with explicitly identified missing fields, thereby reducing redundant user interaction and allowing downstream components to operate on normalized data structures.

The present invention further provides that the processor is configured to generate a first prompt sentence that includes conditions for generating an inquiry sentence to acquire the missing information, to input the first prompt sentence to a generative AI model, and to cause the generative AI model to generate the inquiry sentence, to transmit the inquiry sentence to the terminal device of the user or the gift recipient, to receive answer information via the terminal device, and to analyze and structure the answer information as gift condition information. This enables the processor to use the generative AI model as a dynamic question generator under explicit control of prompt content, improving the efficiency and accuracy of missing-data acquisition and reducing the need for static, hard-coded user interface flows.

The present invention further provides that the processor is configured to execute emotion analysis processing based on the gift condition information, the attribute information, and the transaction history information, thereby estimating at least a sender emotion and a recipient emotion, to generate a second prompt sentence for recommendation that includes a specification for presenting candidate gift items based on the gift condition information and a result of the emotion analysis processing, to input the second prompt sentence to the generative AI model, and to cause the generative AI model to generate gift candidate information, and to select candidate gift items based on the gift candidate information, search results obtained from a product information database, and a preference estimation result for the user. This enables the processor to integrate emotional context and predicted preferences directly into the prompt design and ranking logic, which improves the quality and personalization of the recommendations while reducing the volume of irrelevant candidates that must be retrieved and processed.

The present invention further provides that the processor is configured to acquire and store anniversary information from the terminal device, to detect an anniversary scheduled to occur within a predetermined period, to automatically start a process for generating the candidate gift items for the anniversary by reusing the attribute information, the transaction history information, the emotion analysis processing, and the generative AI model with an internally generated prompt sentence, and to notify the terminal device of the generated candidate gift items. This enables the server to proactively trigger recommendation sessions at the processor level without requiring a new full user-initiated workflow, thereby improving resource utilization and reducing response time when the user accesses the system near an anniversary date.

The present invention further provides that the processor is configured, in response to a request for creating document information to be attached to a gift, to generate a third prompt sentence for document generation that includes at least an emotion state and the gift condition information, to input the third prompt sentence to the generative AI model, to cause the generative AI model to generate a message draft, and to present the message draft to the terminal device. This enables consistent use of the same structured context and emotional state across both product recommendation and message generation, reducing duplicated computation, avoiding separate template engines, and improving the coherence between the selected gift and the accompanying message.

The present invention further provides that the processor is configured to calculate a suitability score for each of a plurality of candidate gift items corresponding to the gift candidate information based on the past transaction history of the user and the estimated emotion state, to rank the candidate gift items according to the suitability score, and to present the ranked candidate gift items to the terminal device, and that the processor is configured to record, as history information, each prompt sentence input to the generative AI model and each response output from the generative AI model, and to update, in a learning manner, at least a generation condition of the prompt sentences and a selection condition of the candidate gift items based on the history information. This enables adaptive optimization of both the prompting strategy and the ranking algorithm over time, improving system-level performance by reducing ineffective calls to the generative AI model, increasing hit rates for relevant recommendations, and enhancing the overall computational efficiency of the server executing the recommendation service.

The term “processor” refers to a hardware processing unit or a combination of hardware processing units that executes instructions to perform data collection, analysis, prompt generation, model invocation, recommendation, and control operations of the system.

The term “attribute information” refers to information describing characteristics of a user or a gift recipient, including at least demographic information, preference information, and relationship information, which is used as input for analysis and recommendation processing.

The term “transaction history information” refers to information indicating records of past commercial transactions associated with a user, including at least identifiers of purchased items, prices, dates, and categories, which is used to infer preferences and behavioral patterns.

The term “storage unit” refers to a hardware storage resource, including at least a memory device or a persistent storage device, that stores attribute information, transaction history information, gift condition information, anniversary information, and history information used by the processor.

The term “terminal device” refers to an electronic device operated by a user or a gift recipient, including at least a portable communication device or a computing device, that provides input and output functions for interaction with the server.

The term “user interface” refers to a software-controlled presentation of input and output elements on a terminal device that enables a user or a gift recipient to input, update, or confirm information and to receive inquiry sentences, recommendations, and message drafts.

The term “natural language gift request” refers to a text or voice input expressed in a human language by a user that describes at least a desire to select a gift and may include contextual details such as recipient information, occasion, budget, or preferences.

The term “gift purpose” refers to a reason or occasion for giving a gift, including at least events such as birthdays, anniversaries, holidays, or expressions of specific sentiments.

The term “gift recipient” refers to a person or entity intended to receive a gift that is selected by the system for a user.

The term “budget range” refers to a monetary interval or constraint specified or inferred for the price of a gift item that is acceptable to the user.

The term “auxiliary condition” refers to additional constraints or preferences for gift selection, including at least hobbies, interests, categories, delivery constraints, or style preferences.

The term “missing information” refers to one or more pieces of information that are required for a gift selection process but are not yet present in the current session context or stored records.

The term “prompt sentence” refers to a text instruction generated by the processor and provided to a generative AI model to guide the model's output toward a desired type of content or structure.

The term “generative AI model” refers to a machine-learned model that receives a prompt sentence as input and generates output data such as inquiry sentences, gift candidate information, or message drafts, using probabilistic or neural generation techniques.

The term “inquiry sentence” refers to a natural language question generated based on a prompt sentence to request specific missing information from a user or a gift recipient.

The term “answer information” refers to one or more responses provided by a user or a gift recipient to an inquiry sentence generated and presented by the system.

The term “gift condition information” refers to structured data derived from answer information, attribute information, and transaction history information, representing constraints and preferences used to select candidate gift items.

The term “emotion analysis processing” refers to a computational process that determines at least one emotional state from textual or other input data, using an emotion model or related algorithm.

The term “sender emotion” refers to an emotional state estimated for a user who intends to send a gift, such as gratitude, celebration, sympathy, or encouragement.

The term “recipient emotion” refers to an emotional state estimated for a gift recipient, such as stress, happiness, anticipation, or comfort.

The term “recommendation prompt sentence” refers to a prompt sentence that includes at least gift condition information and emotion analysis results and that instructs a generative AI model to generate gift candidate information.

The term “gift candidate information” refers to output from a generative AI model representing one or more potential gift options, including at least descriptive names, categories, or characteristics of candidate items.

The term “product information database” refers to a data repository that stores records of items available for gifting, including at least identifiers, names, categories, prices, and descriptive attributes.

The term “preference estimation result” refers to an output of a computational process that predicts preferences of a user for certain types of items based on attribute information and transaction history information.

The term “candidate gift items” refers to specific items selected by the processor as potential gifts, based on gift candidate information, database search results, and preference estimation.

The term “anniversary information” refers to data indicating dates associated with events for which a gift may be desired, including at least birthdays, relationship anniversaries, or commemorative dates.

The term “predetermined period” refers to a time interval defined relative to an anniversary date during which the system is configured to trigger automatic generation of gift recommendations.

The term “document information” refers to text content to be attached or associated with a gift, including at least greeting messages, notes, or dedication texts.

The term “document generation prompt sentence” refers to a prompt sentence that includes at least an emotion state and gift condition information and that instructs a generative AI model to generate message text suitable for attaching to a gift.

The term “message draft” refers to one or more candidate text outputs generated by a generative AI model for use as a greeting or personal message to accompany a gift.

The term “suitability score” refers to a numerical or ordinal value computed for each candidate gift item based on one or more factors, including past transaction history and estimated emotion state, indicating how appropriate the item is for a given scenario.

The term “history information” refers to stored records including at least prompt sentences input to a generative AI model and responses output from the generative AI model, which are used for subsequent analysis or optimization.

The term “generation condition of the prompt sentences” refers to parameters, templates, or rules used by the processor when constructing prompt sentences for the generative AI model.

The term “selection condition of the candidate gift items” refers to criteria or thresholds applied by the processor to filter, rank, or choose among candidate gift items for presentation to the user.

In one embodiment, a server, one or more terminals, and a communication network cooperate to implement the claimed system. The server includes at least one hardware processor, a volatile memory, a non-volatile storage device such as a disk drive or solid-state drive, and a network interface. The terminals include computing devices such as mobile communication devices, tablet devices, and personal computers, each having a display unit, an input unit, a local memory, and a communication module. The server executes software components written, for example, in a high-level language such as Python and running on an operating system such as a general-purpose server operating system. The server uses an application framework such as a web application framework to implement network communication, data access, and user interface delivery.

The server stores attribute information, transaction history information, gift condition information, emotion information, anniversary information, prompt sentences, and history information in structured data stores implemented by a relational database management system such as a relational database engine. The server represents such data in normalized table schemas. For example, the server stores user attribute records in a table with fields for user identifier, demographic attributes, preference tags, and relationship tags. The server stores transaction history records in a table with fields for transaction identifier, user identifier, product identifier, price, date, and category code. The server links these tables through foreign keys so that the processor can efficiently perform join operations using a database driver.

The server generates and maintains feature vectors for users and products in a machine-learning feature store. The server uses a data analysis library such as a numerical computation library and a data frame library to load attribute information and transaction history information from the relational database, to perform preprocessing operations such as normalization, one-hot encoding of categorical variables, and time-based aggregation, and to generate fixed-length numerical feature vectors. The server stores these feature vectors in a vector table with user identifiers or product identifiers as keys. By structuring user and product representations as dense numerical vectors, the server enables matrix and tensor operations in downstream algorithms to be executed efficiently on the processor.

The server implements a generative AI model using a neural network architecture, such as a transformer-based language model, which receives prompt sentences as input and outputs natural language text. In one embodiment, the server uses a pre-trained transformer model accessible through an API, and the server controls the model by constructing prompt sentences with explicit instructions and contextual data. In another embodiment, the server additionally trains an in-house generative language model using a framework such as a deep learning framework, with a multi-layer transformer architecture including an embedding layer, multiple self-attention layers, feed-forward layers, and a final softmax output layer. The server uses a cross-entropy loss as an error function and updates weights by a gradient-based optimizer such as an adaptive moment estimation optimizer.

The server also implements an emotion analysis model. In one embodiment, the server uses a classifier model that receives a tokenized text sequence and outputs a probability distribution over discrete emotion labels such as gratitude, stress, joy, or sadness. The server constructs this model using a neural architecture, such as a bidirectional sequence model or a classifier head on top of a transformer encoder. The server trains the emotion analysis model on labeled training data that associates text with emotion labels. The server uses a categorical cross-entropy function as a loss function and updates model weights using mini-batch gradient descent. The server stores the trained model parameters in the storage unit and loads them into the memory for inference.

The server uses the emotion analysis model to compute sender emotion and recipient emotion. The server receives input text from a terminal, tokenizes the text, converts tokens into embeddings, runs the sequence through the composite neural network, and obtains a vector of emotion probabilities. The server selects the maximum-probability label as the emotion classification result, and stores this label together with confidence scores in an emotion table, indexed by session identifier and role (sender or recipient). By using a fixed architecture and a defined loss function, the server ensures that emotion inference is deterministic given fixed weights and inputs, which allows the system to behave predictably under load and to optimize the ranking of candidate items with consistent semantics.

The server integrates the generative AI model and the emotion analysis model into a modular architecture. The server defines a prompt construction module that receives structured session context and outputs prompt sentences. The server defines an AI invocation module that sends prompt sentences to the generative AI model and receives text responses. The server defines a parsing module that converts responses from the generative AI model into structured data such as question lists, candidate item descriptors, or message text. The server defines a ranking module that assigns suitability scores to candidate gift items based on feature vectors and emotion labels. The server defines a logging module that records prompt sentences and corresponding AI responses as history information.

The server constructs different categories of prompt sentences according to the stage of processing. For missing-information acquisition, the server generates a prompt sentence such as:
“Given that the user is looking for a birthday present for a friend, generate concise follow-up questions to obtain the friend's age, hobbies, and the user's budget.”

For recommendation generation, the server generates a prompt sentence such as:
“The user is looking for a gift for a 30-year-old male friend who enjoys outdoor activities. The user's budget is under 5000 yen. The user feels gratitude toward the friend. Suggest 3 specific gift ideas that match these conditions and briefly explain why each is suitable.”

For document generation, the server generates a prompt sentence such as:
“The sender wants to thank a close friend for always supporting them. Generate a warm, sincere message of about 80 words that can be written on a gift card.”

The server constructs these prompt sentences by filling template strings with fields drawn from structured context objects. The server uses rules to order context segments, to include or omit optional segments, and to add explicit formatting instructions. The server stores the templates in configuration files so that they can be updated independently of code, and the server logs which template and context produced each prompt sentence. This structured prompt construction improves reproducibility and simplifies tuning of the generative model behavior.

The server maintains a session context data structure, stored as a record in a session table and cached in memory, which includes user identifier, recipient identifier, extracted gift purpose, recipient attributes, budget description, auxiliary conditions, estimated emotions, and state flags indicating which information fields are missing or complete. When the server receives natural language input from a terminal, the server runs a natural language understanding component that maps text into slots in the session context structure. For example, the server uses a transformer encoder to produce contextual token embeddings, applies attention or pooling operations to derive an utterance-level vector, and applies linear classifiers to detect entities such as age, relationship type, occasion type, and budget amounts. The server writes the extracted values into the appropriate fields and updates state flags. By storing context in this explicit structure, the server reduces the need for repeated parsing of prior inputs and allows subsequent modules (such as prompt generation and ranking) to query context with constant-time access.

The server uses the stored context to control when to invoke the generative AI model and when to perform deterministic computations. For example, when the server has not yet obtained required fields, the server uses the missing-information list to generate a prompt sentence for question generation. When the server has all required fields, the server directly queries the product information database using SQL to retrieve a candidate set of products constrained by budget, category, and availability, and then uses the generative AI model only to generate descriptive explanations, or to re-rank items if necessary. This conditional control flow reduces unnecessary calls to the generative AI model, thereby lowering latency and computational cost.

The server uses the ranking module to compute a suitability score for each candidate gift item. The server concatenates user feature vectors, product feature vectors, and one-hot encodings of sender and recipient emotions into a single input vector. The server passes this vector through a learned feed-forward neural network with multiple fully connected layers and non-linear activation functions, and obtains a single scalar output representing predicted suitability. The server trains this network using historical interaction data, including which items were clicked, which were purchased, and which received positive feedback from users. The server defines a loss function such as a pairwise ranking loss or a logistic regression loss, and updates weights using stochastic gradient descent. During inference, the server uses the learned weights to compute suitability scores in real time for each candidate item and sorts items accordingly.

The server further maintains anniversary information for recipients. The server stores each anniversary date, associated user identifier, recipient identifier, and context notes in an anniversary table. The server runs background processes on the processor at fixed intervals, querying the anniversary table for dates within a configurable future window, such as a defined number of days. For each matched anniversary, the server creates a recommendation task record, and triggers prompt construction for an anniversary-specific recommendation, incorporating the stored relationship type and any past gifts given for that anniversary. The server then executes the same feature-generation and ranking procedures to produce candidate gift items and sends a notification to the associated terminal. This background processing enables proactive recommendations while keeping database queries and model calls batched and scheduled, which reduces peak load and improves overall system throughput.

The server also implements a history-based improvement mechanism. The server logs each prompt sentence and each generative AI response in a history table, together with metadata such as model parameters used, time of invocation, and subsequent user feedback. Periodically, the server analyzes this history data offline using clustering and regression techniques. The server identifies which prompt templates and which ordering of context segments correlate with higher acceptance rates of recommendations or higher message-editing satisfaction. The server then updates template weights and rules in the prompt construction module to favor more effective patterns. This adaptive tuning results in fewer calls that produce unhelpful or verbose outputs, thereby reducing network payload size and compute cycles consumed by the generative AI model.

The terminals provide user interfaces through web pages or native application screens. The terminals render inquiry sentences, recommendation lists, and message drafts received from the server. The terminals capture user or recipient responses through input controls such as text boxes, selection lists, and buttons. The terminals perform basic validation, such as checking that numeric fields fall within allowed ranges, and then transmit structured data to the server over a secure communication channel. By performing only lightweight validation on the terminal and offloading heavy analysis and model inference to the server, the system preserves battery life on portable devices and leverages the server's optimized hardware and software stack.

The user interacts with the system by inputting natural language requests, answering automatically generated questions, reviewing ranked lists of gift items, and optionally editing message drafts. The user does not manually specify detailed filters or navigate complex menus, because the server determines missing information and generates questions dynamically. This interaction pattern is not a mere automation of a human's mental process of choosing gifts; instead, it leverages the server's ability to coordinate multiple machine-learning models, structured context, and scheduling mechanisms in a way that a human cannot replicate manually, particularly with respect to large-scale data access, database filtering, vector computations, and prompt optimization.

The use of a generative AI model in the claimed system provides technical improvements to the underlying computer operation. The server constructs prompt sentences in a controlled, template-based manner that encodes structured context, and the server uses the resulting outputs as intermediate data within an integrated pipeline. This design reduces entropy in model responses, making parsing and downstream ranking more reliable, which in turn reduces error handling and re-computation. The emotion analysis and ranking modules transform raw text inputs into low-dimensional numerical representations and computed suitability scores, which are more efficient for storage, transmission, and real-time sorting than raw descriptive text. The scheduling of anniversary-triggered recommendations and the logging of prompt-response pairs enables the server to batch and prioritize tasks, improving processor utilization and reducing latency under heavy load.

In another embodiment, the server uses alternative neural architectures, such as a recurrent neural network or a convolution-based text classifier, to implement the emotion analysis model, and uses a different loss function, such as a hinge loss, to train the ranking network. In another variation, the server uses a non-relational database, such as a document store, to maintain session context and history information, while preserving the same logical schema of keys and fields. In yet another embodiment, the server deploys the generative AI model on dedicated accelerator hardware, such as a graphics processing unit or a tensor processing unit, and uses batch inference to handle multiple prompt sentences in a single call. These variations still conform to the claimed structure in which the processor controls data collection, prompt construction, model invocation, candidate selection, and ranking based on structured context, emotion, and history information.

By combining structured data representations, specific neural network architectures, defined loss functions, and a deterministic control flow for prompt generation and recommendation, the system improves the way a computer processes natural language requests, manages user and product data, and generates and ranks recommendation outputs. The server thereby improves technical performance metrics such as average response time, network payload size, recommendation precision, and computational efficiency, and provides a concrete implementation that enables a person skilled in the art to practice the claimed invention.

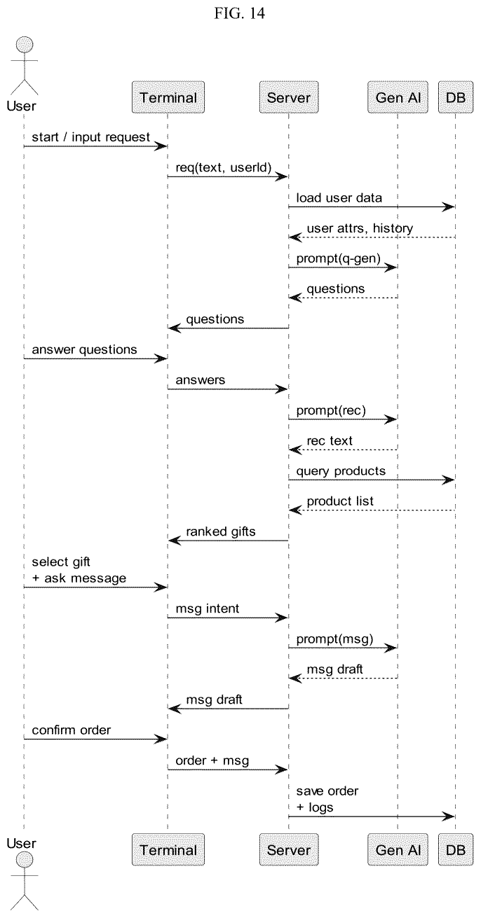

The following describes the processing flow using FIG. 14.

### Step 1:

User operates the terminal to start a gift-selection session and to input an initial natural language request.
Input: A natural language text such as “I am looking for a birthday present for a friend.”
Output: A structured request message transmitted from the terminal to the server.
Terminal displays a start screen, receives the user's text input, wraps the text together with a user identifier and session identifier into a structured message, and sends the message to the server over a secure communication channel.

### Step 2:

Server receives the initial request and initializes a session context.
Input: The structured request message containing user identifier, session identifier, and natural language text.
Output: A new session context record stored in memory and in a session table.
Server parses the request header, verifies the user identifier, allocates a new session identifier if needed, and creates a session context data structure with fields for gift purpose, recipient attributes, budget, auxiliary conditions, and completion flags, initializing these fields to a default “unknown” state.

### Step 3:

Server retrieves attribute information and transaction history information for the user.
Input: The user identifier from the session context.
Output: Preprocessed user attribute vectors and transaction history summary stored in memory.
Server issues database queries to the attribute table and transaction history table, loads resulting records into memory, applies preprocessing such as normalization and categorical encoding using a numerical library, and constructs fixed-length feature vectors representing user characteristics and aggregate purchase behavior.

### Step 4:

Server analyzes the initial natural language request to extract known conditions and to identify missing information.
Input: The initial natural language text and the preprocessed user attribute vectors.
Output: Updated session context with filled fields and a list of missing information fields.
Server runs a natural language understanding component, tokenizes the text, computes embeddings, applies classifier heads to detect entities such as gift purpose, recipient relationship, occasion, and budget range, writes detected values into the session context, sets completion flags for known fields, and produces a list of required fields that remain unset.

### Step 5:

Server generates a prompt sentence for a generative AI model to obtain missing information.
Input: The session context and the list of missing information fields.
Output: A prompt sentence instructing the generative AI model to generate inquiry sentences.
Server selects a prompt template for question generation, fills template placeholders with values from the session context, lists the missing fields explicitly, and constructs a prompt sentence such as “Given that the user is looking for a birthday present for a friend, generate concise follow-up questions to obtain the friend's age, hobbies, and the user's budget.”

### Step 6:

Server calls the generative AI model to generate inquiry sentences.
Input: The constructed prompt sentence.
Output: One or more inquiry sentences in natural language.
Server sends the prompt sentence to the generative AI model through an API, specifies parameters such as temperature and maximum length, receives the generated text, and segments the text into individual questions, forming a list such as “What is your friend's age?”, “What are your friend's hobbies?”, “What is your budget?”

### Step 7:

Server transmits the inquiry sentences to the terminal for display.
Input: The list of inquiry sentences.
Output: A message to the terminal containing the questions.
Server wraps the list of questions into a structured response message associated with the session identifier and sends this message to the terminal via the network interface.

### Step 8:

Terminal displays the inquiry sentences and collects user answers.
Input: The list of inquiry sentences from the server.
Output: A set of user answers transmitted back to the server.
Terminal renders the questions as text elements with corresponding input fields, waits for the user to enter answers such as “He is 30 years old,” “He likes outdoor activities,” and “My budget is within 5000 yen,” performs basic validation on formats, and sends the answers together with the question identifiers to the server.

### Step 9:

Server parses user answers and updates the session context with gift condition information.
Input: The set of answers from the terminal and the current session context.
Output: A fully or partially completed gift condition object stored in the session context.
Server applies natural language parsing to each answer, extracts structured values such as age number, hobby category, and budget upper limit, writes them into the session context fields, and updates completion flags for each corresponding field, thereby forming the gift condition information.

### Step 10:

User optionally requests that the system ask the gift recipient directly for preferences.
Input: A user command such as selecting “Ask the recipient what they want” on the terminal.
Output: A recipient-contact request message sent to the server.
Terminal captures the user's selection, associates it with the current session identifier and recipient contact reference, and transmits this command to the server.

### Step 11:

Server generates a prompt sentence to create an inquiry sentence for the gift recipient.
Input: The recipient-contact request and the session context including relationship and occasion.
Output: A recipient-oriented prompt sentence.
Server constructs a prompt sentence such as “Generate a polite question asking what the recipient would like to receive for their birthday. The sender is a close friend. The message should be friendly and concise,” using a dedicated template and fields from the session context.

### Step 12:

Server invokes the generative AI model to obtain a recipient inquiry sentence and sends it to the recipient's terminal.
Input: The recipient-oriented prompt sentence.
Output: An inquiry sentence delivered to the recipient's terminal.
Server calls the generative AI model with the prompt, receives a generated question like “Your birthday is coming up—what would you be happiest to receive as a gift?”, packages this text into a notification payload, and transmits it to the recipient's terminal via a messaging or notification service.

### Step 13:

Recipient uses the terminal to answer the inquiry sentence, and the terminal sends the answer to the server.
Input: The inquiry sentence displayed on the recipient's terminal.
Output: A recipient preference message transmitted to the server.
Terminal presents the question on a display, accepts the recipient's answer such as “I would love some new noise-cancelling headphones,” and sends this answer, tagged with the relevant session or link identifier, back to the server.

### Step 14:

Server parses the recipient's answer and enriches the gift condition information.
Input: The recipient's answer text and the existing session context.
Output: Updated gift condition information including explicit recipient preference.
Server runs natural language parsing on the answer, identifies key product categories or attributes such as “headphones” and “noise-cancelling,” maps these to standardized category codes and optional price-range hints, and stores this structured preference into the session context under a “recipient preference” field.

### Step 15:

User or recipient provides additional emotional or contextual text, and the terminal forwards it to the server.
Input: Text such as “I want to express my gratitude” or “I feel very stressed lately.”
Output: An emotion-analysis request message.
Terminal captures the text in an emotion input field, associates it with role (sender or recipient), and transmits the text to the server as part of the ongoing session.

### Step 16:

Server performs emotion analysis to estimate sender emotion and recipient emotion.
Input: The emotional text and the emotion analysis model parameters.
Output: Emotion labels and confidence scores stored in the emotion table.
Server tokenizes the text, converts tokens to embeddings, passes the sequence through the emotion analysis neural network, obtains a probability vector over emotion classes, selects the highest-probability emotion label such as “gratitude” or “stress,” and stores the label and associated probabilities in the session context.

### Step 17:

Server compiles all context into a structured representation for recommendation.
Input: Gift condition information, user attribute vectors, transaction history summary, and emotion labels.
Output: A unified recommendation context object.
Server merges user features, recipient attributes, extracted conditions, and emotion classifications into a single data structure, normalizes numerical values, encodes categorical values, and marks that all necessary inputs for recommendation are present.

### Step 18:

Server queries the product information database to obtain a preliminary candidate set.
Input: The recommendation context object including budget, categories, and constraints.
Output: A list of product records matching basic constraints.
Server forms an SQL query that filters products based on price range, category, availability, and any excluded types, sends the query to the database engine, receives the resulting rows, and converts them into internal product feature vectors with identifiers and attributes.

### Step 19:

Server generates a recommendation prompt sentence for the generative AI model.
Input: The recommendation context object and a summary of the preliminary candidate set.
Output: A recommendation prompt sentence.
Server selects a recommendation prompt template, inserts context values such as age, relationship, hobbies, budget, and emotion, and constructs a sentence like “The user is looking for a gift for a 30-year-old male friend who enjoys outdoor activities. The user's budget is under 5000 yen. The user feels gratitude toward the friend. Suggest 3 specific gift ideas that match these conditions and briefly explain why each is suitable.”

### Step 20:

Server calls the generative AI model to generate gift candidate descriptions.
Input: The recommendation prompt sentence.
Output: Textual descriptions of candidate gift ideas.
Server sends the prompt to the generative AI model, receives a response containing a list of suggested items with explanations, segments the response into individual suggestions, and parses each suggestion into name-like phrases and descriptive phrases.

### Step 21:

Server aligns generative AI suggestions with concrete product records.
Input: Parsed candidate descriptions and the preliminary candidate product list.
Output: A mapped list of candidate gift items linked to actual products.
Server computes similarity scores between suggestion keywords and product titles or tags using vector representations, selects the best-matching product or set of products for each suggested type, and builds a candidate list linking each suggested idea to specific product identifiers.

### Step 22:

Server computes suitability scores for each candidate gift item.
Input: Candidate product feature vectors, user feature vectors, and emotion labels.
Output: Numerical suitability scores associated with each candidate.
Server concatenates user, product, and emotion feature vectors, inputs them to a trained ranking neural network, obtains a scalar suitability score for each candidate, and stores these scores along with candidate identifiers in memory.

### Step 23:

Server ranks and filters candidate gift items based on suitability scores and constraints.
Input: The list of candidate gift items with suitability scores and constraint data.
Output: A finalized ranked list of gift items.
Server sorts candidates in descending order of suitability score, removes items that violate any remaining constraints such as delivery region or stock level, trims the list to a defined number of top results, and creates a final recommendation list containing item identifiers, display names, prices, and short explanations.

### Step 24:

Server sends the ranked gift recommendation list to the terminal.
Input: The finalized ranked list of gift items.
Output: A recommendation response message to the terminal.
Server packages the list into a structured message, associates it with the session identifier, and transmits it over the network to the user's terminal.

### Step 25:

Terminal displays the recommended gift items for user selection.
Input: The ranked recommendation list from the server.
Output: User selection input specifying one or more gift items.
Terminal renders each recommended item with an image, name, price, and explanation, allows the user to scroll and inspect details, and provides selection controls so the user can choose items or adjust filters, then sends the user's selection to the server.

### Step 26:

User requests generation of a message to accompany the selected gift, and the terminal forwards this request.
Input: User intent text such as “I want a warm message to thank my friend for always supporting me,” plus selected gift identifiers.
Output: A message-generation request to the server.
Terminal captures the user's textual intent, associates it with the selected items and session identifier, and transmits this information to the server.

### Step 27:

Server generates a document-generation prompt sentence for the generative AI model.
Input: The user's intent text, the session context, and the selected gift information.
Output: A document-generation prompt sentence.
Server constructs a prompt such as “The sender wants to thank a close friend for always supporting them. Generate a warm, sincere message of about 80 words that can be written on a gift card,” incorporating the emotion state and context, and prepares it for model invocation.

### Step 28:

Server calls the generative AI model to generate a message draft and returns it to the terminal.
Input: The document-generation prompt sentence.
Output: One or more message drafts presented to the user.
Server sends the prompt to the generative AI model, receives generated text as a message draft, optionally splits it into alternative versions if present, and transmits the draft or drafts to the terminal as a response.

### Step 29:

User reviews and optionally edits the message draft on the terminal, and the terminal sends the finalized message to the server.
Input: The message draft displayed on the terminal.
Output: Finalized message text returned to the server.
Terminal displays the message draft in an editable field, accepts user edits, and, once the user confirms, sends the final message text back to the server for association with the selected gift.

### Step 30:

Server associates the finalized message with the order record and updates logs.
Input: Finalized message text, selected gift identifiers, and session context.
Output: A completed order record and history entries including prompt sentences and responses.
Server creates or updates an order entry including product identifiers, user identifier, recipient identifier, and the message text, logs the prompt sentences and generative AI outputs for question generation, recommendation, and document generation in the history table, and stores all records in persistent storage.

### Step 31:

Server periodically processes anniversary information to trigger proactive recommendations.
Input: Stored anniversary records and current date/time.
Output: Newly created recommendation tasks and notifications sent to terminals.
Server runs scheduled checks on the anniversary table, selects anniversaries within a predetermined future window, for each creates a recommendation context using stored user and recipient data, generates appropriate prompt sentences for the generative AI model, computes recommendations as in previous steps, and sends reminder notifications with suggested gifts to the corresponding terminals.

### Step 32:

Server periodically analyzes history information to refine prompt generation and ranking behavior.
Input: Logged prompt sentences, generative AI responses, user feedback, and interaction outcomes.
Output: Updated prompt templates and ranking model parameters.
Server runs offline analysis routines that aggregate history records, calculate effectiveness metrics for different prompt templates and ranking configurations, adjust template rules and model hyperparameters, and, where appropriate, retrains or fine-tunes ranking networks so that subsequent online processing uses improved prompts and scoring schemes.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

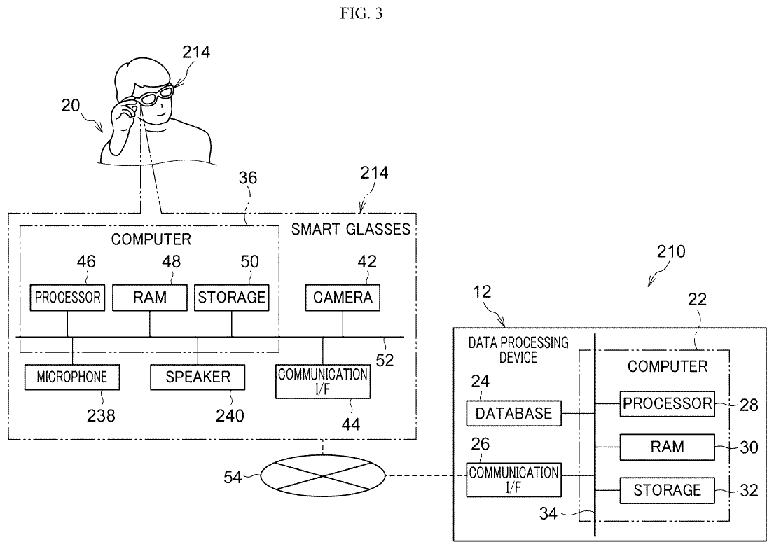

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

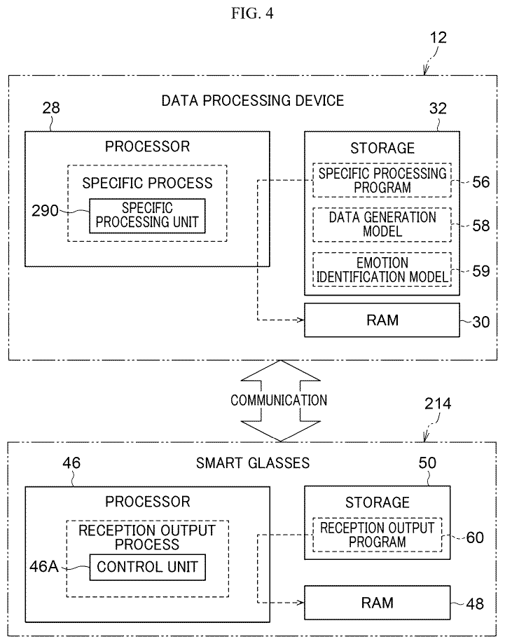

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

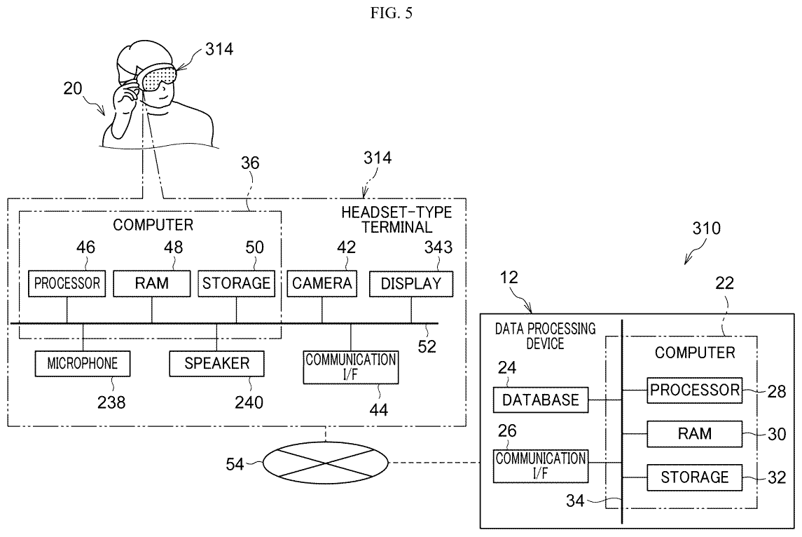

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

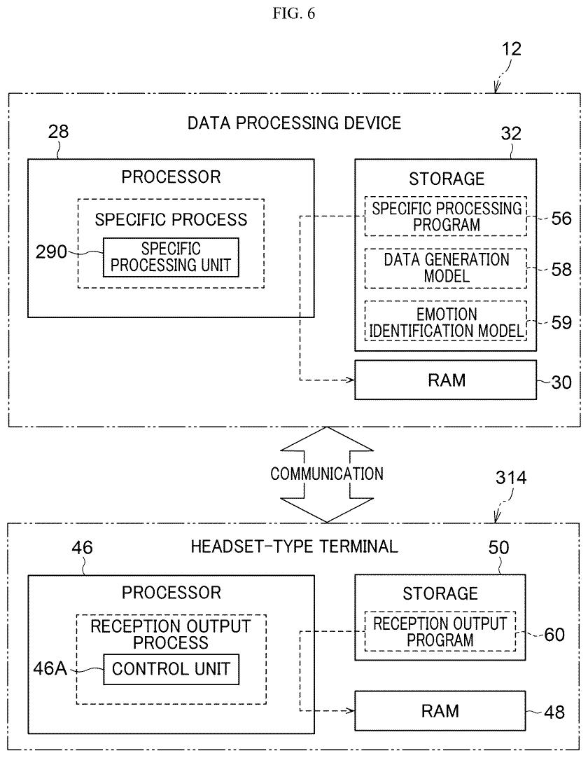

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

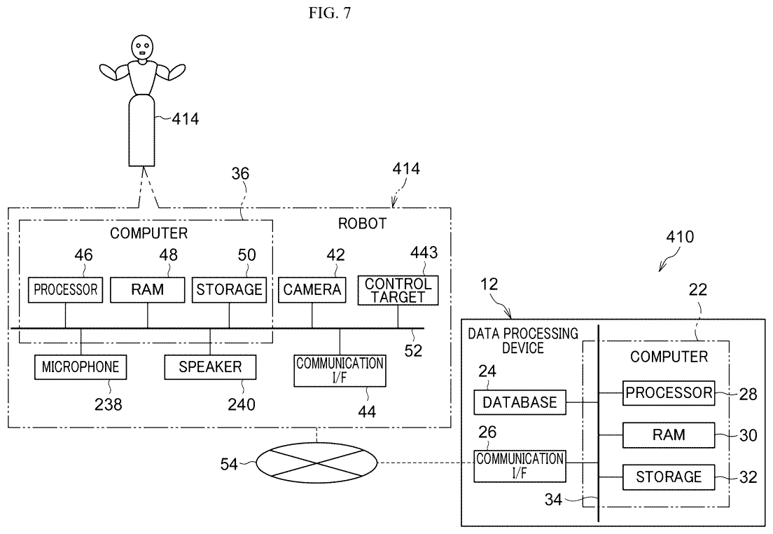

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

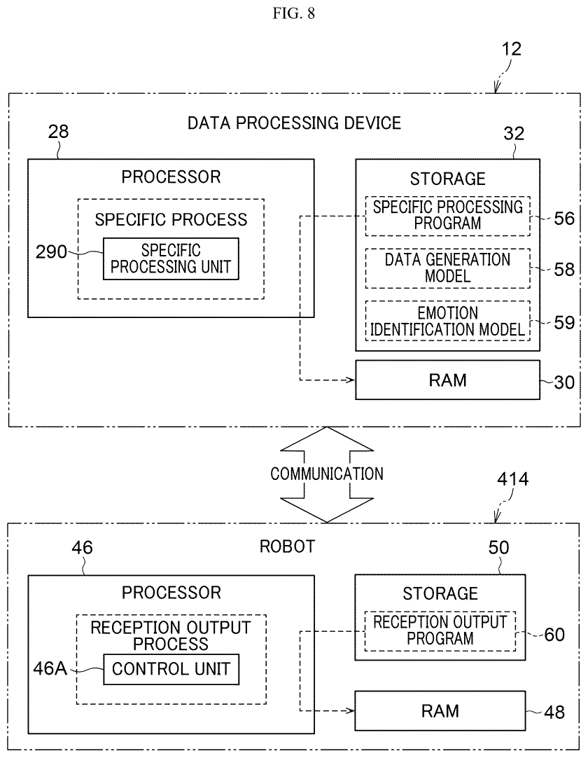

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

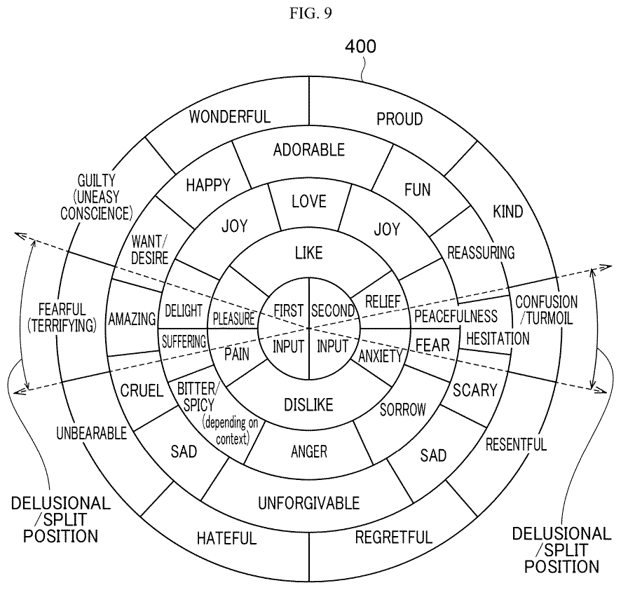

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

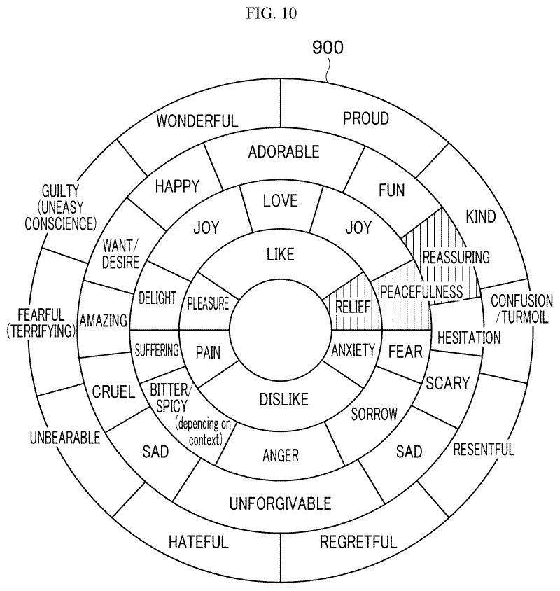

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
acquire user-related information and transaction history information by receiving input information transmitted from a terminal and information obtained from an external information source, and store the acquired information in the storage device,
perform preprocessing on the user-related information and the transaction history information stored in the storage device, the preprocessing including completion of missing values,
normalization of attribute values, and numerical representation of categorical information, and generate a set of feature values as feature data for learning processing,
generate and store a prediction model for user preference as a prediction processing model by training a learning processing model based on the set of feature values and past preference results or purchase results,
input a set of feature values of a user and attribute information of candidate items into the prediction processing model and calculate an evaluation value indicating a degree of preference for each candidate item,
rank the candidate items based on the evaluation values and identify a group of gift candidate items,
construct a prompt sentence for input to a generative information processing model based on the user-related information, the transaction history information, and the group of gift candidate items, and transmit the prompt sentence to the generative information processing model,
obtain generated text from the generative information processing model and generate recommendation reason information and explanation information for each gift candidate item based on the generated text,
transmit the group of gift candidate items and the recommendation reason information to the terminal via a communication network and provide information display so that a user can view and select from the group of gift candidate items, and
acquire a selection result of the user from the terminal, store the selection result in the storage device, and register the selection result as learning data used for relearning or updating of the learning processing model.

### Supplementary 2

The system according to supplementary 1,
wherein the processor is configured to
cause the prediction processing model to calculate the evaluation value indicating the degree of preference for each candidate item using the set of feature values, and identify the group of gift candidate items based on the evaluation values, and cause the generative information processing model to generate, in response to the prompt sentence including the user-related information, the transaction history information, and the group of gift candidate items, a recommendation sentence and an explanation sentence for each of the gift candidate items.

### Supplementary 3

The system according to supplementary 1,
wherein the processor is configured to
construct the prompt sentence to include profile information based on an age category, a gender category, a preference field category, an occupation category, and a purchased item category of the user, and to include item name information, function summary information, and price range information of the group of gift candidate items, and to request the generative information processing model to extract, from the group of gift candidate items, items having higher priority and to generate natural language text explaining a relationship between each extracted item and the profile information.

### Application Example 1

### Supplementary 1

A system comprising a processor,
wherein the processor is configured to
acquire user attribute information and electronic commerce history information, and manage an information storage structure for storing the user attribute information and the electronic commerce history information, and
generate feature information composed of numerical information based on the user attribute information and the electronic commerce history information, and construct a learning information set by associating the feature information with the user attribute information and the electronic commerce history information, and
construct a generative artificial intelligence model based on the learning information set, and store and update the generative artificial intelligence model, and
generate a prompt sentence composed of natural language information including usage situation information based on the user attribute information and the electronic commerce history information and gift-giving scene information, and form input information to the generative artificial intelligence model by combining the prompt sentence and the feature information, and
cause the generative artificial intelligence model to generate gift candidate information corresponding to gift target information by inputting the input information into the generative artificial intelligence model, and specify a product set based on the gift candidate information, and
transmit the product set to a user terminal device, and store, as feedback information, selection result information and evaluation information acquired from the user terminal device in the information storage structure, and
perform relearning of the generative artificial intelligence model based on the feedback information and the learning information set to improve generation accuracy of the gift candidate information.

### Supplementary 2

The system according to supplementary 1,
wherein the processor is configured to
generate the prompt sentence as a natural language sentence including a description of the user attribute information and the electronic commerce history information, and gift-giving purpose information and gift-giving condition information, and use the prompt sentence as an input instruction to the generative artificial intelligence model.

### Supplementary 3

The system according to supplementary 1,
wherein the processor is configured to
acquire, as the feedback information, product identification information of a product selected from the product set displayed on the user terminal device and evaluation scale information, generate relearning information by associating the product identification information and the evaluation scale information with the learning information set, and update parameter information of the generative artificial intelligence model based on the relearning information.

### Example 2

### Supplementary 1

A system comprising a processor,
wherein the processor is configured to
store user attribute information and transaction history information as data used for a learning process,
acquire, via a terminal including a display device and an input device for dialog, a natural language request sentence from a user regarding a gifting purpose, and receive dialog-start information including the request sentence,
generate a prompt sentence to be input to a generative language model based on the request sentence and the user attribute information and the transaction history information, and
transmit the prompt sentence to the generative language model so as to cause the generative language model to generate question sentences for inquiring additional input items regarding a gift recipient,
transmit the question sentences obtained from the generative language model to the terminal, and normalize user input acquired from the terminal as answers to the question sentences so as to extract attribute conditions and budget conditions of the gift recipient,
issue a search request to a product information database based on the attribute conditions and the budget conditions, and select gift candidates by scoring a plurality of product information items acquired from the product information database, and
transmit at least part of the selected gift candidates to the terminal as proposal information for display on the terminal.

### Supplementary 2

The system according to supplementary 1,
wherein the processor is configured to
embed, into the prompt sentence, context information including the request sentence and the user attribute information and the transaction history information, add instruction information to the generative language model specifying a number, an expression format, and types of contents of the question sentences regarding the gift recipient, transmit the prompt sentence including the instruction information to the generative language model, and manage the question sentences obtained from the generative language model in association with session identification information.

### Supplementary 3

The system according to supplementary 1,
wherein the processor is configured to
perform a computation process for calculating a relevance score for each of the plurality of product information items acquired from the product information database by using a preference estimation result based on the user attribute information and the transaction history information, and rank the gift candidates based on the relevance scores and transmit the ranked gift candidates to the terminal.

### Application Example 2

### Supplementary 1

A system comprising a processor,
wherein the processor is configured to
collect and preprocess attribute information and transaction history information regarding a user of the system, and store the collected information in a storage unit,
provide, to a terminal device, a user interface for allowing the user or a gift recipient to input or update the attribute information and the transaction history information,
analyze a natural language gift request received from the terminal device so as to extract at least a gift purpose, a gift recipient, a budget range, and auxiliary condition information, and identify missing information required for gift selection,
generate a prompt sentence including conditions for generating an inquiry sentence for acquiring the missing information, and input the prompt sentence to a generative AI model so as to cause the generative AI model to generate the inquiry sentence,
transmit the inquiry sentence generated by the generative AI model to the terminal device of the user or the gift recipient, receive answer information from the terminal device, analyze the answer information, and structure the answer information as gift condition information,
execute emotion analysis processing based on the gift condition information and the attribute information and the transaction history information so as to estimate a sender emotion and a recipient emotion,
generate a recommendation prompt sentence including a specification for presenting candidate gift items based on the gift condition information and a result of the emotion analysis processing, and input the recommendation prompt sentence to the generative AI model so as to cause the generative AI model to generate gift candidate information,
select candidate gift items based on the gift candidate information, search results obtained from a product information database, and a preference estimation result for the user, and transmit information on the candidate gift items to the terminal device,
acquire and store anniversary information from the terminal device, detect an anniversary scheduled to occur within a predetermined period, automatically start a process for generating the candidate gift items for the anniversary, and notify the terminal device of the generated candidate gift items, and
in response to a request for creating document information to be attached to a gift, generate a document generation prompt sentence including at least an emotion state and the gift condition information, input the document generation prompt sentence to the generative AI model so as to cause the generative AI model to generate a message draft, and present the message draft to the terminal device.

### Supplementary 2

The system according to supplementary 1,
wherein the processor is configured to calculate a suitability score for each of a plurality of candidate gift items corresponding to the gift candidate information based on a past transaction history of the user and an estimated emotion state, and to rank the candidate gift items according to the suitability score and present the ranked candidate gift items to the terminal device.

### Supplementary 3

The system according to supplementary 1,
wherein the processor is configured to record, as history information, the prompt sentence input to the generative AI model and a response output from the generative AI model, and to update, in a learning manner, a generation condition of the prompt sentence and a selection condition of the candidate gift items based on the history information.

What is claimed is:

1. A system comprising:
circuitry configured to:
receive, via a packet-switched network, profile attribute data and interaction history records from a terminal device, and store the profile attribute data and the interaction history records in a storage device;
perform preprocessing on the profile attribute data and the interaction history records to produce feature vectors;
train a prediction neural network using the feature vectors and labeled outcome data by executing iterative optimization to adjust weight parameters of the prediction neural network, and store the weight parameters in the storage device;
execute forward inference through the prediction neural network using a feature vector associated with a user of the terminal device and feature vectors of candidate items to produce evaluation score values for the candidate items, and identify a selected group of the candidate items based on the evaluation score values;
construct a structured prompt for a generative neural network model based on the profile attribute data and attribute data of each candidate item in the selected group, and transmit the structured prompt to an information processing apparatus hosting the generative neural network model via the packet-switched network;
receive a generated output token sequence from the generative neural network model and extract descriptive annotation data for each candidate item in the selected group;
transmit a response data structure comprising the selected group and the descriptive annotation data to the terminal device via the packet-switched network to cause rendering on a display of the terminal device;
receive selection result data from the terminal device and store the selection result data in the storage device; and
update the prediction neural network using the selection result data as additional labeled outcome data.

2. The system according to claim 1, wherein the preprocessing comprises detecting missing values in the profile attribute data and the interaction history records and replacing the missing values according to a predetermined substitution rule, normalizing numerical attribute values by applying a scaling function, and converting categorical attribute values into numerical vector representations using an encoding technique.

3. The system according to claim 2, wherein the encoding technique comprises one-hot encoding that maps each categorical attribute value to a binary vector, or embedding index encoding that maps each categorical attribute value to an index in a learned embedding table.

4. The system according to claim 3, wherein the circuitry is further configured to:
compute aggregate statistical values from the interaction history records comprising at least frequency values per category, recency values, average transaction magnitude values, and diversity measures across categories, and append the aggregate statistical values to the feature vectors to produce enhanced feature vectors used for training the prediction neural network.

5. The system according to claim 4, wherein the prediction neural network comprises a plurality of fully connected layers with non-linear activation functions, and the circuitry executes forward inference by performing matrix multiplications of combined input tensors with the weight parameters and applying the non-linear activation functions at each layer to produce the evaluation score values.

6. The system according to claim 5, wherein the iterative optimization comprises defining a logistic loss function over the feature vectors and the labeled outcome data, computing gradients of the logistic loss function with respect to the weight parameters via backpropagation, and updating the weight parameters using an adaptive learning rate optimizer over a plurality of training epochs.

7. The system according to claim 6, wherein the profile attribute data comprises at least an age category, a gender category, a preference field category, an occupation category, and a historical item category of the user, and the structured prompt includes the age category, the gender category, the preference field category, the occupation category, and the historical item category formatted as natural language phrases.

8. The system according to claim 7, wherein the selected group of candidate items comprises gift candidate items, and the structured prompt instructs the generative neural network model to generate recommendation reason information and explanation information for each gift candidate item based on a relationship between the gift candidate item and the profile attribute data of the user.

9. The system according to claim 8, wherein the structured prompt further includes price range information and function summary information for each gift candidate item, and requests the generative neural network model to extract from the selected group items having higher priority and to generate natural language text explaining the relationship between each extracted item and the profile attribute data.

10. The system according to claim 1, wherein the circuitry is further configured to:
transmit the structured prompt to the generative neural network model with configuration parameters comprising at least a maximum output token length value and a sampling strategy parameter.

11. The system according to claim 10, wherein the generative neural network model comprises a transformer-based decoder network, and the circuitry transmits the structured prompt as a sequence of input tokens and receives an auto-regressively generated output token sequence.

12. The system according to claim 1, wherein updating the prediction neural network comprises constructing new training samples from the selection result data and the feature vectors, recalculating gradients of a loss function with respect to the weight parameters, and adjusting the weight parameters based on the recalculated gradients.

13. The system according to claim 12, wherein the circuitry is further configured to:
periodically retrain the prediction neural network by accumulating a batch of selection result data records from a plurality of users and executing the iterative optimization on the accumulated batch to produce updated weight parameters.

14. The system according to claim 13, wherein the circuitry is further configured to:
update normalization parameters and regularization terms of the prediction neural network during the periodic retraining based on statistical properties of the accumulated batch.

15. The system according to claim 1, wherein the circuitry is further configured to:
provide an input interface on the terminal device through which the user enters the profile attribute data and views previously stored interaction history records, the terminal device validating format constraints on the entered profile attribute data before transmitting to the circuitry via the packet-switched network.

16. The system according to claim 15, wherein the circuitry is further configured to:
render the selected group on the display of the terminal device in a structured layout comprising item names, image references, price values, the evaluation score values, and the descriptive annotation data, and provide selectable interface elements through which the user indicates the selection result data.

17. The system according to claim 1, wherein the circuitry is further configured to:
parse the generated output token sequence by identifying segments corresponding to numbered labels embedded in the structured prompt, extract an annotation sentence from each identified segment, and map each annotation sentence to a corresponding candidate item identifier using the numbered labels.

18. A system comprising:
circuitry configured to:
receive, via a packet-switched network, profile attribute data and interaction history records from a terminal device and from an external information processing apparatus, and store the profile attribute data and the interaction history records in a storage device;
perform preprocessing on the profile attribute data and the interaction history records comprising detecting and replacing missing values, normalizing numerical attribute values, and converting categorical attribute values into numerical vector representations to produce feature vectors, and compute aggregate statistical values from the interaction history records and append the aggregate statistical values to the feature vectors to produce enhanced feature vectors;
train a prediction neural network using the enhanced feature vectors and labeled outcome data by executing iterative gradient-based optimization of a loss function to adjust weight matrices, and store trained parameters in the storage device;
construct combined input tensors from a target feature vector of a user and candidate item feature vectors, execute forward inference through the prediction neural network to produce evaluation score values, and rank candidate items to identify a selected group comprising gift candidate items;
construct a structured prompt for a generative neural network model by inserting profile information comprising at least an age category, a gender category, a preference field category, and an occupation category of the user, and item attribute data of each gift candidate item into a predefined template, and transmit the structured prompt to an information processing apparatus hosting the generative neural network model via the packet-switched network;
receive a generated output token sequence, parse the generated output token sequence to extract recommendation reason information and explanation information for each gift candidate item;
transmit the gift candidate items, the evaluation score values, and the recommendation reason information to the terminal device via the packet-switched network to cause rendering on a display of the terminal device;
receive selection result data from the terminal device, store the selection result data in the storage device; and
retrain the prediction neural network using the selection result data as updated labeled outcome data.

19. The system according to claim 18, wherein the circuitry is further configured to:
construct the structured prompt to include price range information and function summary information for each gift candidate item and to request the generative neural network model to generate natural language text explaining a relationship between each gift candidate item and the profile information.

20. A method performed by circuitry, the method comprising:
receiving, via a packet-switched network, profile attribute data and interaction history records from a terminal device, and storing the profile attribute data and the interaction history records in a storage device;
performing preprocessing on the profile attribute data and the interaction history records to produce feature vectors;
training a prediction neural network using the feature vectors and labeled outcome data by executing iterative optimization to adjust weight parameters of the prediction neural network, and storing the weight parameters in the storage device;
executing forward inference through the prediction neural network using a feature vector associated with a user of the terminal device and feature vectors of candidate items to produce evaluation score values for the candidate items, and identifying a selected group of the candidate items based on the evaluation score values;
constructing a structured prompt for a generative neural network model based on the profile attribute data and attribute data of each candidate item in the selected group, and transmitting the structured prompt to an information processing apparatus hosting the generative neural network model via the packet-switched network;
receiving a generated output token sequence from the generative neural network model and extracting descriptive annotation data for each candidate item in the selected group;
transmitting a response data structure comprising the selected group and the descriptive annotation data to the terminal device via the packet-switched network to cause rendering on a display of the terminal device;
receiving selection result data from the terminal device and storing the selection result data in the storage device; and
updating the prediction neural network using the selection result data as additional labeled outcome data.
